(19) United States
(12) Patent Application Publication
(10) Pub. No.: US 2025/0191479 A1
(43) Pub. Date: Jun. 12, 2025

(54) RECONFIGURABLE PUZZLE FOR EDUCATION, THERAPY, AND ENTERTAINMENT

(71) Applicant: Tusi, LLC, Lafayette, IN (US)

(72) Inventors: Jurgen ZACH, Lafayette, IN (US); Karun Tahilramani, Chesapeake, VA (US)

(21) Appl. No.: 18/843,682

(22) PCT Filed: Mar. 1, 2023
(86) PCT No.: PCT/US2023/014304

§ 371 Date: Sep. 5, 2024

Related U.S. Application Data
(60) Provisional application No. 63/315,405, filed on Mar. 1, 2022.

(51) Int. Cl. G09B 1/40; A63F 13/2145; A63F 13/26; A63F 13/285; A63F 13/31; A63F 13/327; G09B 23/18

(52) U.S. Cl. CPC G09B 1/40; A63F 13/2145; A63F 13/285; A63F 13/31; A63F 13/327; A63F 13/26; G09B 23/183

(57) ABSTRACT

A reconfigurable puzzle for providing education, therapy, and entertainment is disclosed. The reconfigurable puzzle comprises a set of individual puzzle pieces with reconfigurable electronic display screens on at least one side, wherein one individual puzzle piece is mechanically connected with a connecting puzzle piece along one of the four surface areas using one or more mechanical connectors. Each of the at least one display screen of each individual puzzle piece is reconfigured to display parts of an image. Each individual puzzle piece comprises a processing unit having at least one wired interface including at least two wires. The processing unit is configured to transmit and receive data via the at least two wires of the at least one wired interface. Further, the display screens are aligned in a correct pattern configured to display a composite image of the individual images on the display screens of the individual puzzle pieces.

### TECHNICAL FIELD

The present invention generally relates to puzzle games. More specifically, the present invention relates to a reconfigurable puzzle for education, therapy, and entertainment.

### BACKGROUND

Tiled puzzles are pictures segmented into regularly or irregularly shaped flat tiles, or pieces. Each of the pieces shows a small part of a picture, typically on one side, sometimes on both. When the pieces are assembled on a two-dimensional surface in a certain set of relative positions, the completed picture is shown. Generally, there is only one correct way to assemble puzzles, and if one single piece is missing or damaged, the picture cannot be completed as intended.

Nowadays, most puzzles are manufactured and sold in the form of jigsaw puzzles, which are sets of irregularly shaped small pieces, mostly made of cardboard and sometimes other materials such as wood or plastic. Typically, neighbouring puzzle pieces connect mechanically through mutually interlocking shapes. In many cases again, a correct mechanical fit is unique to one pair of sides of two specific puzzle pieces.

The main applications of puzzles are leisure activities for adults and children and educational and developmental visual and tactile aids for early childhood education. Although there is no strict division, the number of pieces per picture depends on the age of the user targeted, and ranges from less than ten for toddlers; ten to hundred for pre-school and kindergarten children; hundreds for elementary school children; and one or several thousand for teenagers and adults.

According to the historical record, the first commercial jigsaw puzzle was invented in the 18th century by the British cartographer and engraver John Spilsbury who attached geographic maps on a hardwood surface and cut them into segments with a marquetry saw. The sets were sold as “dissected maps” and used to teach geography to children. The tiled puzzle, or jigsaw puzzle, was therefore originally invented as an educational tool. No information was found on whether Mr. Spilsbury filed a patent or protected his invention otherwise, but it is clear that the original concept of jigsaw puzzles has entered the public domain.

Nowadays, the educational use of puzzles is centered on the age range from early childhood-to elementary school applications in the home- and family setting, and from pre-school-to early elementary school in public and private education settings. Like John Spilsbury's original invention, a major use case both at home and in school is still teaching geography to children, but educational puzzles now target topics in science, history, social studies, and many other topics. Besides aiming to teach the subject or topic depicted in the puzzle's image, puzzles are recognized by the scientific and educational community to foster reasoning, spatial, memory, and math skills and even bonding with caregivers. For that reason, puzzles are also proven and recognized to play a role in therapies stimulating cognitive functions in individuals developing brain disorders such as dementia or Alzheimer. Similarly, puzzles are also used in many therapeutical settings for certain populations with special needs or learning disabilities, including autism spectrum disorder and other disorders, as well as other medical conditions.

While the benefit of puzzles in education and in fostering cognitive abilities are well recognized, their frequency and intensity of usage are limited by the following Limiting Factors. One major limiting factor is a static image. Puzzles today display a static image that cannot be changed. In organized childhood education (pre-schools, kindergartens, elementary schools, or similar institutionally organized learning), a given puzzle is therefore only assembled by a given group of learners (such as a class in a school) once or, at most, a few times (such as in the case of geographic map puzzles). Generally, persons imparting knowledge (such as teachers, proctors, education facilitators, parents, therapists, curriculum designers, or other persons tasked with imparting knowledge) and learners do not find it beneficial or are not motivated to, disassemble and reassemble one puzzle multiple times. Hence, puzzles in today's organized childhood education setting are only used occasionally, as only a limited number of puzzle sets can be maintained in the education setting.

Another limiting factor is a limited selection. In the home or family setting, where parents and other caregivers use puzzles as educational toys, the static, non-changing pictures displayed on puzzles are even more limiting, since caregivers would have to purchase puzzle sets periodically to keep the learners' attention focused on the activity by frequently introducing new pictures. Not all caregivers may have the resources to purchase many puzzles. Further, the selection of motives and themes shown on puzzles that have educational benefits, in a given field of learning, from the viewpoint of caregivers is limited. For example, it is easy to find puzzles that depict maps of the world, or populous countries, and still feasible in the case of maps of individual states or provinces. However, it is usually not possible to purchase a puzzle depicting maps of a geographic region within a state or province, or of a town or community other than a major city in which a learner might reside. The same applies to specific topics of math, native or foreign language acquisition, science, social studies, history, and many other subjects.

Another limitation is the lack of interaction. Once a puzzle is fully assembled, no further interaction with the puzzle is possible, that is, learners both in home and family settings and in organized childhood education do not spend much time processing and studying the picture showing the actual content to be taught to the learner. To the contrary, completed puzzles show pictures that may be attractive, but are not special in today's world of ubiquitous digital media and easily available print media such as books, and therefore do not capture learner's attention. At best, they may be used as wall art equivalent to posters once assembled.

Another limitation is the limited haptic capability. While the interlocking edges of puzzle pieces in the case of jigsaw puzzles provide tactile information to the learner while assembling the puzzle, most puzzles are flat, two-dimensional surfaces that only utilize the visual sense once the puzzle is fully assembled. Exceptions are puzzles for very small children, typically made of plastic or wood, which feature three-dimensional structures for the learner to touch after full assembly. In practice, cost and size considerations limit these three-dimensional relief puzzles to a small number of pieces, typically ten or less. The small number of pieces results in three-dimensional relief puzzles not be demanded by more advanced learners, such as older children. Further, the relief motives themselves are again static and cannot be reconfigured.

Another limitation is the lack of multimedia capability. Puzzles now, by their nature, do not provide any possibility to be augmented by audio interaction (sound generation and/or perception), moving or changing images, or other multimedia content. Adding such options would lend puzzles significant competitive leverage in competing with ubiquitous digital media.

One way to make puzzles more interesting and tangible is three-dimensional versions of puzzles. Three-dimensional puzzles are widely available now, for both children and adults. Three-dimensional jigsaw puzzles (“3D puzzles”) were first invented in 1991 by Paul Gallant, who went on to cofound the Canadian company Wrebbit. The invention was patented, and the original patents were assigned to Wrebbit, which was the only company legally selling 3D puzzles-brand-named Puzz-3D in the jurisdictions the patents covered. Wrebbit was acquired by the multinational toy company Hasbro in 2005, and Wrebbit's original patents are assigned to Hasbro now. Wrebbit 3D puzzles continue to be made from polyethylene foam, laminated by paper which depicts an image, color, or picture. The pieces are assembled in three dimensions, with the final product intended to represent a three-dimensional object. Objects depicted by Wrebbit include historic and modern architecture, imagined architecture from entertainment books, movies, or television series, and some other objects and themes. During the term of its patent, Wrebbit did not target end uses in early childhood education, persons with challenges in cognitive development, or educational themes beyond architecture. Since the expiration of Wrebbit/Hasbro's original patents in 2012, a number of other manufacturers are offering 3D puzzles with a broader range of themes, which now include educational themes such as globes for geography, human anatomy, and engineering. Some of these have resulted in protected intellectual property.

The same limitations found in the case of two-dimensional (2D) puzzles apply to three-dimensional (3D) puzzles: (i) static images, (ii) unavailability of a wide range of most motives, pictures, or 3D shapes following an instructor- or proctor-selected curriculum or instructional content, (iii) no possible interaction with the images, motives, or themes depicted or reproduced as a 3D shape, (iv) no tactile interaction with the 3D shape once it is finished, and (v) no multimedia extension options. While the further intellectual property has been developed in the form of flexible foam pieces, as well as manufacturing methods for 3D puzzle, none of these patents attempt to address the above limiting factors (i)-(v).

Few of the existing puzzles utilize the integration of new multisensory-capable technologies in puzzles, which are new types of display screens available that aim to provide tactile feedback or other more complex interactions, adding an extra sensory element to the user experience. Some of these have been applied in educational settings and therapy. However, none of the latter have managed to be integrated with the experience of a puzzle set with discrete, detachable, reconfigurable pieces. In addition, several types of 3D generalizations of jigsaw puzzles with electronic enhancements have been tested or are available in the marketplace, however, none include reconfigurable displays.

Therefore, the present invention is developed to maintain the idea of a puzzle that is assembled from discrete pieces that, at the same time, can, in many embodiments, address the limiting factors (i)-(v). Based on available peer-reviewed literature, it is expected that overcoming some or all of the limiting factors (i)-(v) by providing one or more of the following features in a puzzle. The puzzle will have numerous advantages in education, therapy, and intellectually stimulating game play such as reconfigurable puzzle, individualized content on puzzles, curriculum-based content displayed on puzzles, interactive puzzles, multisensory puzzles, multimedia beyond still visual images on puzzles. The present invention is the first implementation that provides multiple from among the latter capabilities.

Hence, there is a need for a reconfigurable puzzle configured to provide numerous advantages in education and entertainment. Also, there is a need for a reconfigurable puzzle for cognitive tests and non-invasive therapies.

### SUMMARY

The present invention generally discloses a reconfigurable puzzle. Also, the present invention discloses a reconfigurable puzzle for education and entertainment. Further, the present invention discloses a reconfigurable puzzle for cognitive tests and non-invasive therapies for dementia.

In one embodiment, the reconfigurable puzzle comprises a set of individual puzzle pieces with reconfigurable electronic display screens on at least one side. In one embodiment, the connectors mating is achieved by forming an attachment that exerts an attractive force such as friction or magnetism once connectors are mated and an attempt is made to pull them apart with a force below a separation threshold. In one embodiment, one individual puzzle piece is mechanically connected with a connecting puzzle piece along one of the four surface areas using one or more mechanical connectors. In one embodiment, the individual puzzle pieces are connected using a protruding magnet and a recessed opposite-polarity magnet. The mechanical connections to other puzzle pieces are accomplished by mating the protruding magnet in one puzzle piece to the recessed magnet in the connecting puzzle piece, and the recessed magnet in the one puzzle piece to the protruding magnet in the connecting puzzle piece.

In one embodiment, each individual puzzle piece comprises a processing unit having at least one wired interface including at least two wires. The processing unit is configured to transmit and receive data via the at least two wires of the at least one wired interface. In one embodiment, the at least two individual puzzle pieces are assigned a unique identifier among all the individual puzzle pieces to exchange data via the at least one wired data interface. The exchanged data include the identification of the respective connected puzzle pieces through the unique identifier to one puzzle piece, and other data to be relayed to a puzzle piece, and yet other data received from the connected puzzle pieces. In one embodiment, two individual puzzle pieces are connected using at least one mating connector located on at least one surface of each puzzle piece that does not contain a display screen.

In one embodiment, each display screen of each individual puzzle piece is reconfigured to display parts of an image. In one embodiment, the display screens are aligned in a correct pattern configured to display a composite image of the individual images on the display screens of the individual puzzle pieces.

In one embodiment, each mating connector includes at least two electrical connectors, each of which forms a conductive pathway with another connector on another puzzle piece. The mating connectors are held together by the mechanical connectors or magnets or a combination of both. In one embodiment, one of the at least two connectors include at least two conductors configured to form an electrical connection with one of at least two conductors in another puzzle piece.

In one embodiment, each mating connector includes an electrical energy storage unit configured to supply power to the display screens and processing unit, and at least one electrical connection that is connected to a local electrical ground within the puzzle piece, and another electrical connection that is connected to a voltage other than ground.

In one embodiment, the puzzle pieces are configured to exchange the stored electric energy from one puzzle piece to the connected puzzle piece. The electrical energy is transferred from the puzzle piece that is less discharged to the puzzle piece that is more discharged via the connected grounds and connected voltages other than ground in each connector. In one embodiment, the set of puzzle pieces actuates a user interface signal on an external device to indicate successful assembly of the set of puzzle pieces or unsuccessful assembly of the set of puzzle pieces.

In one embodiment, the reconfigurable puzzle further comprises at least one sensor integrated into at least one puzzle piece having at least one digital display screen displaying a segment of a static or moving image that is part of a complete static or moving image. The at least one sensor and at least one display screen included in each puzzle piece are connected to at least one processing unit that controls the image displayed on any connected display screen. In one embodiment, the at least one sensor is actuated and configured to display a modified image segment on at least one digital display screen of the same puzzle piece the sensor is integrated in or display another modified image segment on the at least one other display screen connected to the at least one other processing unit.

In one embodiment, the reconfigurable puzzle further comprises an audio sensor connected to a first processing unit configured to encode audio signals generated by a user, and a plurality of other processing units connected to at least one digital display screen. The digital display screen shows a different segment of a complete static or moving image.

In one embodiment, the reconfigurable puzzle further comprises a touchscreen integrated into one of the individual puzzle pieces that includes at least one digital display screen. The touchscreen is connected to at least one processing unit that controls the image displayed on any connected display screen. The processing unit in the reconfigurable puzzle piece in which the at least one actuated sensor is integrated is connected through wired or wireless communication interfaces to at least one other processing unit that is connected to at least one other display screen that shows another segment of the complete image. In one embodiment, each digital display screen displays a different segment of a static or moving image that is part of a complete static or moving image. In one embodiment, the touchscreen is actuated and configured to display a modified image segment on at least one from among any digital display screen.

The above summary contains simplifications, generalizations, and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 shows a flat cuboid puzzle piece with a display screen for reconfigurable images on top and a mechanical and electrical connector to mate with other puzzle pieces, according to an embodiment of the present invention.

FIGS. 2A-2B show a set of puzzle pieces, with each similar to the one shown in FIG. 1, in the final stages of assembly (top) and fully assembled (bottom) in a flat, two-dimensional (2D) pattern, according to one embodiment of the present invention.

FIGS. 3A-3B show a set of puzzle pieces, or part of a set of puzzle pieces, with each similar to the one shown in FIG. 1, in the final stages of assembly (top) and fully assembled (bottom), where the educational content shown is an example from electronics engineering, according to one embodiment of the present invention.

FIGS. 4A-4B show a set of puzzle pieces, or part of a set of puzzle pieces, with each similar to the one shown in FIG. 1, in the final stages of assembly (top) and fully assembled (bottom), where the educational content shown is an example from foreign language acquisition, according to one embodiment of the present invention.

FIGS. 5A-5B show the reconfigurable nature of puzzle sets using a set, or part of a set of, puzzle pieces, where the educational content shown is from basic math, according to one embodiment of the present invention.

FIG. 6 shows the connection of puzzle pieces in a 2D pattern through antisymmetric connectors with the ability to universally connect with all other puzzle pieces with the display screen face oriented towards the same side, according to one embodiment of the present invention.

FIG. 7 shows puzzle pieces with one possible connector configuration for the exchange of data and power when being connected, according to one embodiment of the present invention.

FIG. 8 shows a possible design of the electronics detecting the connection of two puzzle pieces, prior to connection, according to one embodiment of the present invention.

FIG. 9 shows a possible design of the electronics detecting the connection of two puzzle pieces, after connection, according to one embodiment of the present invention.

FIG. 10 shows the puzzle pieces with a possible connector configuration for the exchange of data when being connected, for communications protocols other than equal peer-connections, according to one embodiment of the present invention.

FIG. 11 shows a cuboid puzzle piece with reconfigurable images on the display screen with connectors with adjustable angles for 3D puzzle applications, according to one embodiment of the present invention.

FIG. 12 shows an example of a three-dimensional reconfigurable puzzle built, according to one embodiment of the present invention.

FIG. 13 shows a learner interacting with a flat assembled puzzle set with some or all puzzle pieces equipped with touchscreens, with a simple math problem shown as an example, according to one embodiment of the present invention.

FIG. 14 shows a learner interacting with a flat assembled puzzle set with some or all puzzle pieces equipped with touchscreens, where the puzzle piece is equipped with a processing unit to recognize patterns on the touchscreen, with a simple language acquisition problem shown as an example, according to one embodiment of the present invention.

FIG. 15 shows a learner interacting with a puzzle piece equipped with haptic feedback through vibrations, according to one embodiment of the present invention.

FIG. 16 shows a puzzle piece equipped with audio input and output devices, according to one embodiment of the present invention.

FIG. 17 shows a block diagram of major components of a puzzle piece, according to one embodiment of the present invention.

FIG. 18 shows a block diagram of major components of a puzzle piece, according to another embodiment of the present invention.

FIG. 19 shows a puzzle piece with two visible display screens and one side with a concentric-electrode connector, according to one embodiment of the present invention.

FIGS. 20A-20B show a number of puzzle pieces with taller cuboid shapes connected to form a complex 3D structure, according to one embodiment of the present invention.

FIG. 21 shows an example illustrating unique features of the reconfigurable puzzle with proven clinical benefits, according to one embodiment of the present invention.

FIG. 22 shows Montreal Congnitive Assessment (MoCA) administered as an assembly test, according to one embodiment of the present invention.

FIG. 23 shows finger-tapping test, according to one embodiment of the present invention.

FIGS. 24A-24B show Corsi's block tapping test, according to one embodiment of the present invention.

FIG. 25 shows a personalized assembly test, according to one embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

As used herein, the term “Learner” or “User” (both terms are used interchangeably; plural: “Learners” or “Users”), anywhere in this document (other than differing definitions) is referring to any and all of the following, unless stated otherwise: a student or pupil in a school, preschool, homeschool setting, kindergarten, daycare, college, university, adult continuing education, or any other formal or informal educational setting who is assembling or otherwise interacting with any embodiment of the present puzzle set in order to obtain an educational, learning, or teambuilding benefit; OR: a client or patient in a therapeutic, rehabilitation, or other medical setting, ordered or prescribed by a therapist or medical professional or otherwise, in an inpatient-, outpatient-, or home care setting, who is assembling or otherwise interacting with any embodiment of the present puzzle set in order to improve, train, or evaluate their cognitive abilities or sensory perception, or who is assembling or otherwise interacting with any embodiment of the present puzzle set in order to alleviate any medical condition for which the medical community (in the widest sense, including psychologists, therapists, social workers, or counselors) suggests puzzles to be beneficial; OR: a child or other dependent in a home setting who is assembling or otherwise interacting with any embodiment of the present puzzle set for general developmental or entertainment purposes; OR: any person assembling or otherwise interacting with any embodiment of the present puzzle set for game play and entertainment purposes.

As used herein, the term “Persons imparting knowledge” to Learners for the purposes of this invention shall include “Teachers”, “Proctors”, “Education Facilitators”, “Parents”, “Therapists”, “Curriculum Designers”, or any other person directly interacting with a Learner to facilitate or support the Learners' or Users' learning-, therapy-, developmental-, and entertainment objectives, whereas the mention of a specific kind of “Person imparting knowledge” in a specific example shall be generalized to any such person in any setting. For example, mentioning a teacher facilitating a Learner obtaining an educational benefit by assembling or otherwise interacting with any embodiment of the present puzzle set shall imply Therapists facilitating a Learner or User, as defined above, obtaining a therapeutic or other medical benefit out of assembling or otherwise interacting with any embodiment of the present puzzle set. Further, mentioning a specific category of “Persons imparting knowledge”, such as a teacher, shall imply any “Person imparting knowledge” in the appropriate setting.

As used herein, the term “Content Designer” or the corresponding plural “Content Designers” shall, anywhere in this document, refer to a natural person or an algorithm designing content for any embodiment of invention presented here in the form of visual-, audio-, other information that can be perceived by senses, or configuration programming that determined how a Learner or User can interact with a puzzle set. In many cases, “Content Designers” will be “Persons Imparting Knowledge”, as defined above. Wherever mention is made of a specific Person Imparting Knowledge, such as a Teacher or a Therapist, it is always assumed that, at least in some embodiments of the invention, they can be a Content Designer.

As used herein, the term “Content Analysts” or the corresponding plural “Content Analysts” shall, anywhere in this document, refer to a natural person or an algorithm analyzing the interaction of a Learner or User with any embodiment of the invention, wherein the interaction is measured by sensors included in the embodiment, and the sensor data processed in such a way that it can be perceived by the Content Analyst. Sensors may include means to determine the connection between puzzle pieces and their timing, comprising the assembly timeline of any embodiment of the puzzle. Depending on the embodiment, sensors may include any input devices through which Learners or Users can interact with the corresponding embodiment through haptic means (touch), audio, or any other means. In many cases, “Content Analysts” will be the same persons or algorithms as “Content Designers”, but they may be entirely different. In many educational or therapy settings, there will be multiple “Content Analysts”, such as measuring short-term versus long-term success. Wherever mention is made of a specific Person Imparting Knowledge, such as a Teacher or a Therapist, it is always assumed that, at least in some embodiments of the invention, they can be a Content Analyst.

As used herein, the term “Correct Configuration”, “Correct Assembly”, “Correct Solution”, used interchangeably with each other, of a number of puzzle pieces defines the puzzle pieces connected in a certain relative arrangement that the Content Designer sets as a goal for the Learner to achieve as they assemble the puzzle. In some embodiments, there is a unique “Correct Configuration”, whereas in other embodiments, there are multiple “Correct Configurations”. The following terms are used interchangeably in this document: “Correct Configuration”, “Correct Assembly”, “Correct Way to Assemble”, and “Correct Pattern”.

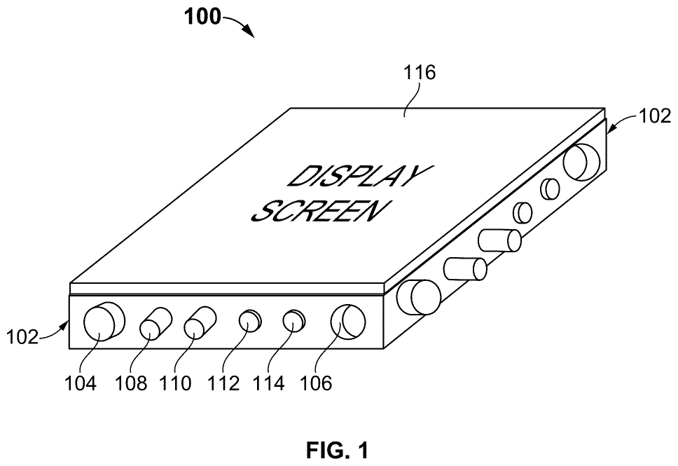

Referring to FIG. 1, a flat cuboid reconfigurable puzzle piece 100 with a display screen 116 for reconfigurable images on top, is illustrated. The puzzle piece 100 comprises one or more mechanical connectors and one or more electrical connectors to mate with other puzzle pieces. In many embodiments, the display screen 116 is integrated into the puzzle piece 100. The display screen 116 is located on one of the larger areas of the puzzle piece 100. In one embodiment, one of the larger areas may be a top surface of the puzzle piece 100, henceforth, the opposite side is referred to as a bottom surface. In one embodiment, the length and width of the puzzle piece 100 may be much larger than its height.

In one embodiment, each puzzle piece comprises one or more mechanical connectors to reversibly attach to at least one other puzzle piece. The puzzle can thus be assembled by attaching multiple puzzle pieces 100 together in a connected pattern. There are multiple ways in which a puzzle set can be assembled, but there is only at least one correct configuration in which it is correctly assembled, so that, typically, most configurations are not correct as intended. When correctly assembled, the resulting display screens aligned in the correct pattern comprise a composite image of the individual images displayed on the puzzle pieces' 100 display screens 116. In some embodiments, the puzzle pieces may have variety of many different shapes that allow for a connection with neighboring puzzle pieces. Due to the wide availability of square or rectangular display screens, the most readily accessible embodiments will include square or rectangular cuboid puzzle pieces. In some embodiments, the puzzle piece 100 may include non-rectangular and any other shape of display screens.

In one embodiment, the puzzle pieces 100 mechanically connect with other puzzle pieces along one of the four surface areas that contain the height. The connection areas are defined either by {height-length-height-length} or {height-width-height-width}. In some embodiments, mechanical connectors on the connection area of the puzzle piece 100 for connecting to another puzzle piece may include mechanical connectors based on friction forces. In other embodiments, the connections between the puzzle pieces 100 are made through a connecting surface 102. The connecting surface 102 comprises one or more mechanical connecting elements and one or more electrical connecting elements. In some embodiments, the connection between the puzzle pieces 100 are made through the mechanical connecting elements. The mechanical connecting elements are a protruding magnet 104 and a recessed opposite-polarity magnet 106. Mechanical connections to other puzzle pieces are accomplished by mating the protruding magnet 104 in one puzzle piece to the recessed magnet 106 in a connecting puzzle piece, and the recessed magnet 106 in the one puzzle piece to the protruding magnet 104 in the connecting puzzle piece. The electrical connecting elements are one or more spring-loaded pins or pogo-pins (108 and 110) and one or more conductive pads (112 and 114).

In some embodiments, the puzzle piece 100 further includes means for connecting the puzzle pieces to detect the connection. In some embodiments, the puzzle piece 100 further includes means for the connected puzzle pieces to exchange data. The exchanged data may include the identification of the respective connected puzzle pieces through identifiers unique to one puzzle piece, and other data to be relayed to a puzzle piece, and yet other data received from a connected puzzle piece. In one embodiment, the data exchanged may include visual data for output on a display screen on a specific puzzle piece, data from sensors included on a specific puzzle piece, or any other data.

In many embodiments, connected puzzle pieces further allow for the exchange of stored electric energy from one puzzle piece 100 to a connected puzzle piece. In some embodiments, wireless identification of connected puzzle pieces is possible, as is wireless power transfer. However, in most embodiments, wired connections to identify connected puzzle pieces are more reliable than, and wired power exchange is far more efficient than wireless power transfer. Therefore, most embodiments will include wired connections between connected puzzle pieces. The term “wired” is to be understood in the widest sense as describing a continuous conductive pathway, such as facilitated by connectors. The wired connection is comprised of one or more spring-loaded pins (“pogo-pins”) and one or more conductive pads. In one embodiment, the wired connection is comprised of two spring-loaded pins or pogo-pins (108 and 110) and two conductive pads (112 and 114) on each connecting side. When connecting, the pogo-pins (108 and 110) on one puzzle piece mate with the conductive pads (112 and 114) on the connecting, and vice versa.

In one embodiment, the puzzle sets are assembled by the learner or user by connecting at least two puzzle pieces along a continuous surface. In some embodiments, the continuous surface may be a two-dimensional (2D) and a flat surface. In some embodiments, the continuous surface may be a three-dimensional (3D) surface. In one embodiment, the puzzle set is configured by a content designer such that at least one possible continuous surface formed by attaching the puzzle set's constituent puzzle pieces is defined as a “Correct Solution”, as defined by the content designer, of the puzzle set. In most embodiments, the continuous surface will form continuously connected, or possibly almost continuously connected with small gaps in between, display screens that comprise a composite image.

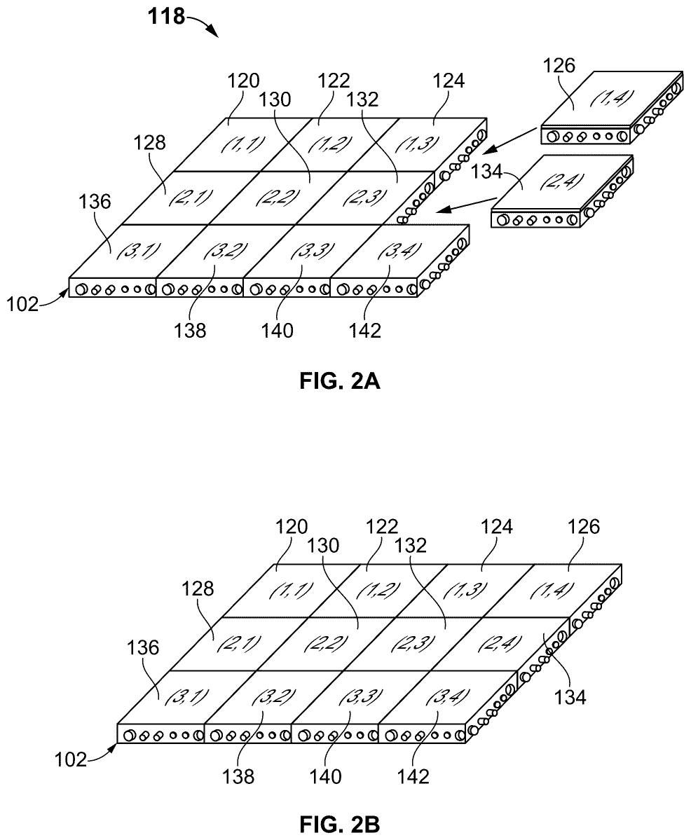

Referring to FIGS. 2A-2B, a puzzle set 118 consisting of a plurality of flat cuboid puzzle pieces (120, 122, 124, 126, 128, 130, 132, 134, 136, 138, 140, and 142) that form a connected surface formed as a larger flat cuboid, is illustrated. The content designer has configured the puzzle set 116 to form a correct solution when the puzzle pieces (120, 122, 124, 126, 128, 130, 132, 134, 136, 138, 140, and 142) are aligned in a unique configuration. The unique configuration is defined by the placement of the puzzle pieces (120, 122, 124, 126, 128, 130, 132, 134, 136, 138, 140, and 142) in a coordinate system illustrated by the 2-tuple printed on the puzzle pieces. In one embodiment, the first digit of the tuple represents the row, and the second digit represents the column. The puzzle set 118 assembled in FIG. 2A has two missing puzzle pieces (126 and 134) from the main body of the puzzle set 116 and is mechanically attached. The puzzle set 118 assembled in FIG. 2B shows a fully assembled puzzle set in the unique correct solution. In some embodiments, each puzzle piece (120, 122, 124, 126, 128, 130, 132, 134, 136, 138, 140, and 142) in the correct solution has four neighboring pieces it shares connecting surfaces 102 within the interior of the assembled surface, three neighbors with connecting surfaces 102 on the edge of the assembled surface, and two neighbors with connecting surfaces 102 on one of the four corner spots.

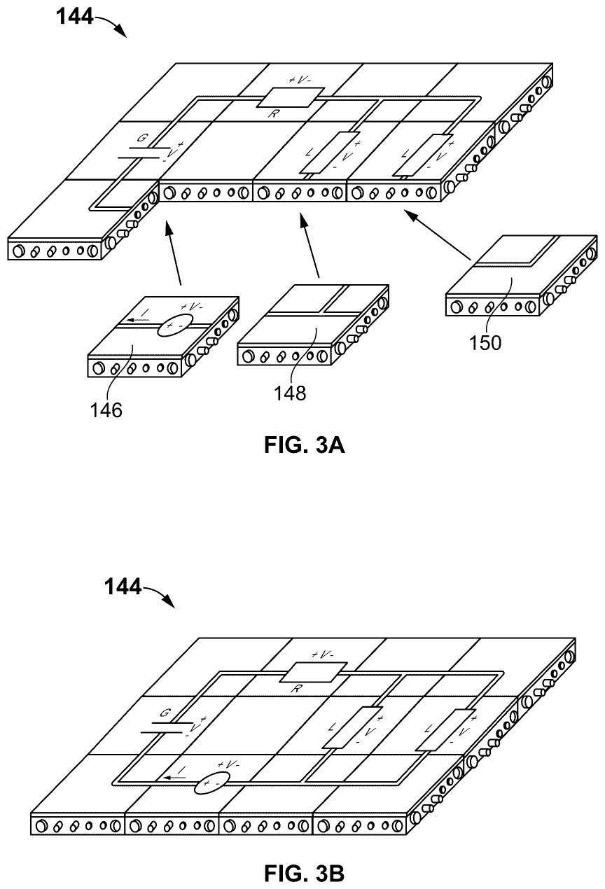

Referring to FIGS. 3A-3B, a set of puzzle pieces or part of a set of puzzle pieces to provide a puzzle assembly 144, with each similar to the one shown in FIG. 1, in the final stages of assembly and fully assembled, are illustrated. In most preferred embodiments of the invention, the scope of images to which the puzzle sets can be configured to by the Content Designer is wide. The puzzle assembly 144 displays an educational content. In one embodiment, the educational content shown in the puzzle assembly 144 is an example from electronics engineering. FIG. 3B shows one of the configuration's unique Correct Solution 144, which is an electronic circuit. FIG. 3A shows most of the electronic circuit correctly assembled, forming the attached grouping of puzzle assembly 144, whereas the three last pieces (146, 148, and 150) are about to be connected to the main puzzle assembly 144. Since there is no limit on the number of puzzle pieces, FIG. 3A-3B can be generalized to circuits with any complexity by adding additional rows and columns as illustrated in FIGS. 2A-2B.

The puzzle assembly 144 is not meant to imply a preference for engineering or even technical topics rather, the same concept is readily applicable to many topics including education, therapy, play, games, and play-based learning. Examples may include likenesses of persons, such as persons known to a user, images of objects or places a user is familiar with, or written language acquisition.

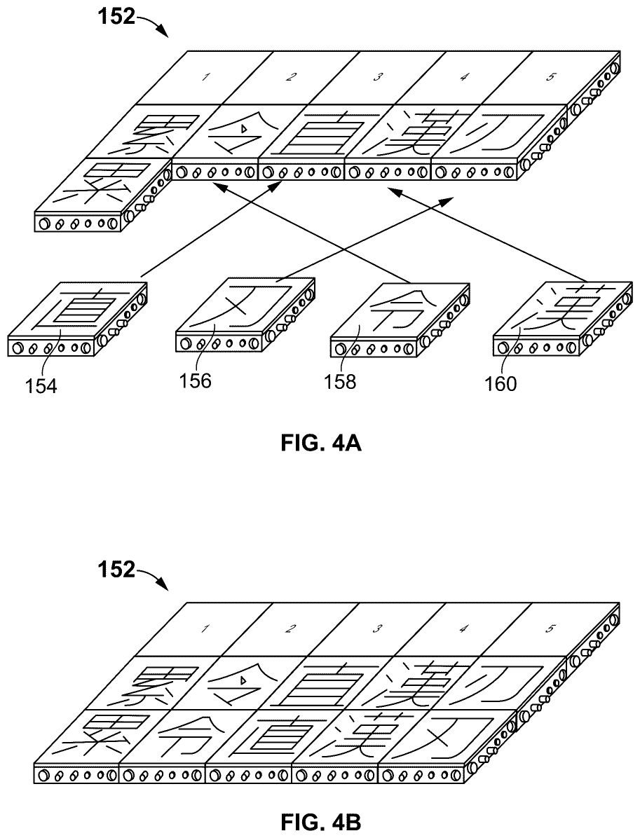

Referring to FIGS. 4A-4B, a set of puzzle pieces, or part of a set of puzzle pieces for providing a puzzle assembly 152, with each similar to the one shown in FIG. 1, in the final stages of assembly and fully assembled are illustrated. In most preferred embodiments of the invention, the scope of images which the puzzle sets can be configured to by the Content Designer is wide. The puzzle assembly 152 displays an educational content. In one embodiment, the educational content shown is an example from foreign language acquisition. FIG. 4B shows a puzzle set configured to test translation skills among written languages with non-Latin writing in particular, the example shows a translation from Chinese to Japanese writing. The partially assembled puzzle set 152 in FIG. 4A shows a complete row of Chinese characters and few missing puzzle pieces (154, 156, 158, and 160). The goal of the puzzle is to sort the correct Japanese translations and attach them to the appropriate column corresponding to a Correct Solution. For example, the puzzle piece 154 needs to be attached to the third column, the puzzle piece 156 to the fifth column, the puzzle piece 158 to the second column, and the puzzle piece 160 to the third column. An assembled Correct Solution is shown in FIG. 4B. In some embodiments, the reconfigurable puzzle set assembly 152 can be readily applied for different European, Middle Eastern, South Asian, and Southeast Asian alphabets and their phonetic representations, such as Latin; Cyrillic; Greek; Arabic, Hebrew, and other Middle Eastern writing systems, Hindi, and other South Asian alphabets; Vietnamese, Thai, and other Southeast Asian alphabets; and any other writing systems.

Further, the puzzle assembly 152 can be used as a teaching tool for modern writing systems such American sign language and other sign languages. In same embodiments, the puzzle assembly 152 can be further used to teach languages which are mastered by few people on a native level, and which are at risk of disappearing as spoken languages without institutional support. Examples are Native American languages and other languages spoken by a smaller number of people around the world. The lack of literature and teaching tools in these languages results in the present invention being an important tool to facilitate language acquisition. FIGS. 4A-4B can be generalized to language content with any configuration and complexity by adding additional rows and columns (as illustrated in FIGS. 3A-3B).

In some embodiments, the puzzle assembly 152 used for language teaching can be applied to mathematics education, such as completing mathematics puzzles that represent simple or complex math problems from algebra, geometry, calculus, and other fundamental math topics.

A key feature of most embodiments of the invention is non-unique Correct Solutions accessible to Content Designers. This contrasts with existing static puzzles, which generally have only one unique Correct Solution. Reconfigurable puzzle sets covered by the present invention can be set up to present the possibility of more than one Correct Solution for a given configuration designed by a Content Designer.

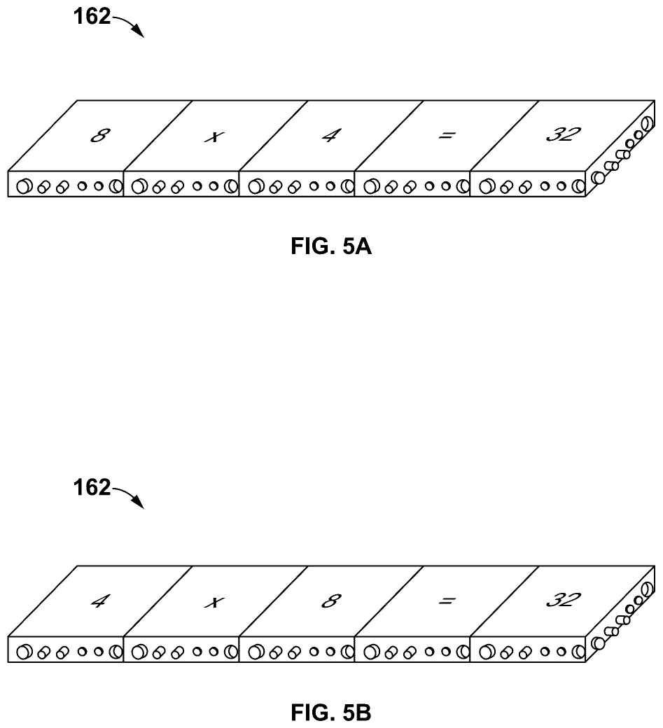

Referring to FIGS. 5A-5B, a puzzle set or part of a puzzle set 162 in which the commutative property of multiplication is illustrated. In the same way, the reconfigurable puzzles presented here can assume many different Correct Solutions in fields including language acquisition, math, engineering, art & design, and many other fields.

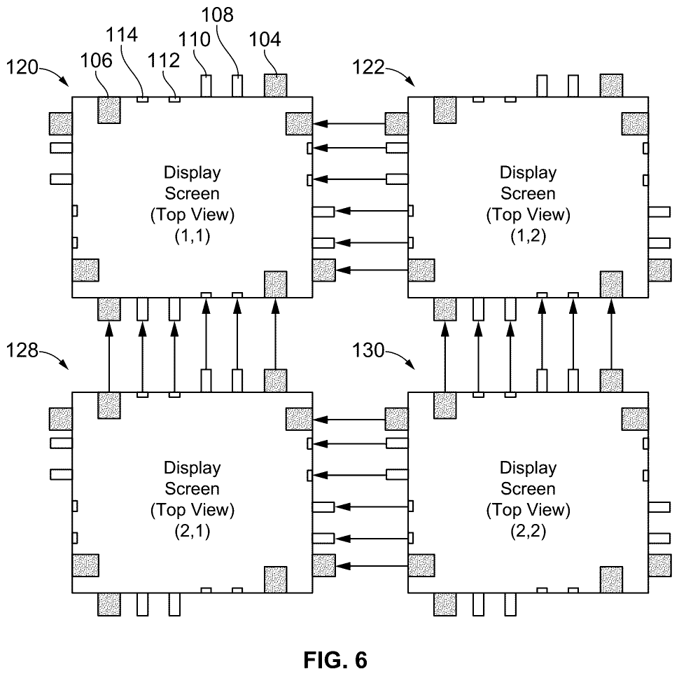

Referring to FIG. 6, a connection between puzzle pieces (120, 122, 128, and 130) in a 2D pattern through anti-symmetric connectors with the ability to universally connect with all other puzzle pieces with the display screen face oriented towards the same side is illustrated. In one embodiment, each puzzle piece (120, 122, 128, and 130) includes one or more mechanical connectors with wired data- and/or power connections. In many embodiments, all connectors are designed such that connectors on any puzzle piece can mate with at least one connector on each of all other puzzle pieces in the puzzle set.

In one embodiment, the puzzle pieces (120, 122, 128, and 130) are square cuboids with four identical connecting sides with corresponding identical connectors. The identical connectors consist of protruding mechanical connector 104, a recessed mechanical connector 106, one or more protruding electrical connectors or pogo-pins (108 and 110) and one or more recessed electrical connectors or flat conductive pads (112 and 114) such that for each protruding element on any side, there is a flat or recessed element at a symmetric point relative to the center of any side. For example, there are protruding mechanical element 104 and electrical elements (108 and 110) on the right side of each connector or connecting side, and recessed element 106 and flat electrical conductive elements (112 and 114) on the left side. The right or left is defined as seen from the center of each puzzle element, looking down onto the display screen, or the Top. As a result, each puzzle piece (120, 122, 128, and 130) can be attached to any other puzzle piece in the set on any side, as long as the display screen is on the same side.

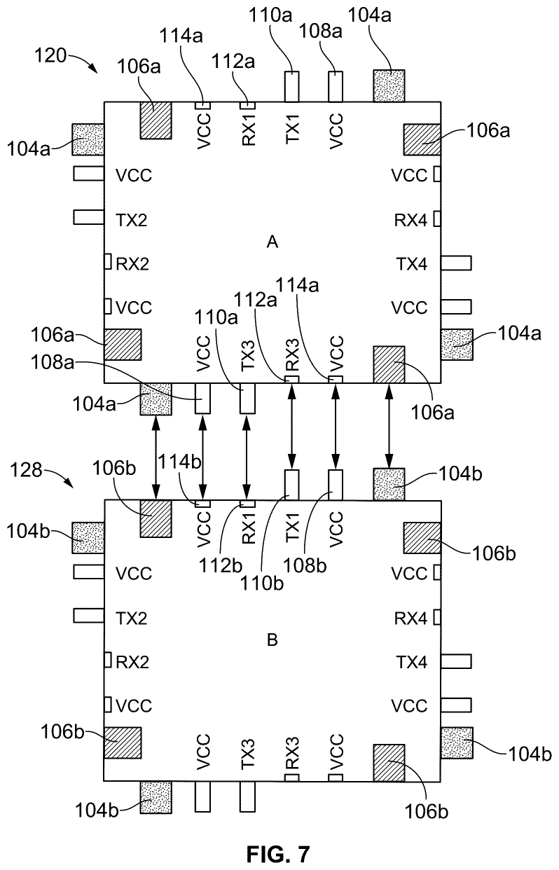

Referring to FIG. 7, one configuration of a connector and its method of connecting two puzzle pieces (120 and 128) is illustrated. The connector on each of the four sides of the puzzle pieces (120 and 128) comprises a protruding mechanical connecting element 104a, a recessed mechanical connecting element 106a, a pair of spring-loaded electrically conductive pins, such as “pogo”-pins (108 and 110), and a pair of flat conductive pads connectors or recessed electrical contacts (112 and 114). In some embodiments, the protruding mechanical connecting element 104a may be a magnet of one polarity. In some embodiments, the recessed mechanical connecting element 106a may be a magnet of the opposite polarity.

Each puzzle piece (120 and 128) has the connecting element 102 on all four sides. Side 3 of the first puzzle piece 120 mates with Side 1 of the second puzzle piece 128 (the numbers do not imply any limitation). In one embodiment, the protruding mechanical element 104a of the first puzzle piece 120 connects with the recessed mechanical element 106b of the second puzzle piece 128; the protruding mechanical element 104b of the second puzzle piece 128 connects with the recessed mechanical element 106a of the first puzzle piece 120. In some embodiments, both mechanical connections may also include electrical connections and may be sustained through magnetic attraction or through mechanical means such as friction, depending on the specific embodiment. Further, the protruding electrical connectors (108b and 110b) of the second puzzle piece 128 connect with the flat or slightly recessed electrical contacts (114a and 112a) of the first puzzle piece 120; and the protruding electrical connectors (108a and 110a) of the first puzzle piece 120 connect with the flat or slightly recessed contacts (112b and 114b) of the second puzzle piece 128. The mechanical connectors may not rely on protruding and recessed shapes at all but be maintained in place by magnets alone.

In some embodiments, a specific relative rotational orientation of two connecting puzzle pieces is required, either arising through geometric constraints of only one pair of sides of two puzzle pieces fitting together, or through the definition of a predefined direction along which all puzzle pieces are configured to be aligned. In some embodiments, the predefined directional constraint may require the display screen on each puzzle needs to be oriented “top-sided” in the direction of the drawing. If the embodiment represented in FIG. 7 is further a cuboid with a square top surface, any Side (1 through 4) of the first puzzle piece 120 may connect with any Side (1 through 4) of the second puzzle piece 128. If the top surface is a rectangle instead of a square, a specific Side of the first puzzle piece 120 can only connect with some sides of the second puzzle piece 128. For example, Side 1 in the first puzzle piece 120 can connect with only Side 1 or Side 3 in the second puzzle piece 128, if Sides 1 and 3 refer to either the smaller side or the larger side in a rectangle in both puzzle pieces (120 and 128).

In many embodiments, when two puzzle pieces (120 and 128) are fully connected, the distance between neighboring display screens may be zero or close to zero, or very small. In other embodiments, the separation of the main enclosures of connected puzzle pieces (120 and 128) is less important, if both include flexible display screens that can overlap.

In many embodiments, the display screen will rely on paper-like display technologies such as electrophoretic displays or electroluminescent displays, also popularly referred to as “electronic ink”, or “e-ink”. The latter may be protected trademarks or names of corporate entities in some jurisdictions; therefore, this document shall refer to the technology summarily as paper-like displays. Paper-like displays are a type of screen that requires significant power only when the displayed image changes but does not consume power to maintain a non-moving image. For many applications of the present invention, paper-like displays are the most suitable choice, as images displayed by the puzzle pieces only change the displayed images infrequently, and in many cases only during configuration or reconfiguration by a Content Designer. That results in a paper-like display screen not contributing to the power budget as long as the displayed image does not change, which is a useful property in light of the fact that display screens other than paper-like displays are often the main power drains in mobile devices. Hence, paper-like displays will result in a long battery life for each puzzle piece.

Nevertheless, other embodiments of the invention may require greater speed and color depth than paper-like displays can provide. In addition, paper-like displays tend to be more expensive than many other types of display screens; hence, if battery life is not a great constraint, such as in applications in which the battery can be conveniently and very frequently recharged, or in case of the availability of wireless charging, other display screens may be employed, which can include any electronic display screens such as Liquid Crystal Displays (LCD); Organic Light Emitting Diodes (OLED); emerging technologies such as inorganic mini-LEDs and micro-LEDs; and any other present and future electronic display methodology.

In one embodiment, the puzzle pieces (120 and 128) may be configured such that, when connected, they exchange data, power, or both. In one embodiment, the two connected puzzle pieces (120 and 128) exchange both data and stored power as needed. The protruding and recessed mechanical connectors (104a, 106a, 104b, and 106b) also serve as a local electric ground for the puzzle pieces (120 and 128). When connected, both puzzle pieces (120 and 128) thus share the same ground. In some embodiments, the ground is power ground. In some embodiments, the ground is signal ground. In other embodiments, the ground is both signal and power ground. The far right-sided protruding electrical contact or pogo-pin (108a or 108b), as well as the far left-sided flat or slightly recessed electrical contact (114a or 114b) may, for example, serve as voltage rail for power (“VCC”). The VCC (108a, 114a, 108b, and 114b) and GND-pins (104a, 106a, 104b, and 106b) of the puzzle pieces (120 and 128) are connected through two redundant connections. The second protruding or pogo-pin (110a or 110b) from the right on each connector serves as a data transmission pin, and the second flat or slightly recessed electrical contact (112a or 112b) serves as a data receiving pin. When connected, each transmitting pin (110a or 110b) of a connector is connected to a receiving pin, for example, TX1 pin 110b of the second puzzle piece 128 is connected to RX3 pin 112a of the first puzzle piece 120, and RX1 pin of the second puzzle piece 128 is connected to TX3 pin 110a of the first puzzle piece 120.

In an embodiment, the connected puzzle pieces (120 and 128) communicate through serial peer-to-peer communications, in which connected puzzle pieces will act as equal communication nodes. Among commercially available protocols, Universal Asynchronous Receiver/Transmitter (UART) can be readily applied to the connecting configuration shown in FIG. 7, if the UART is run in full duplex mode. UART interfaces can rely on two to four wires, wherein the minimum set of wires is a transmitter (Tx) and receiver (Rx) on each communication node (associated with one connecting side in FIG. 7), which are connected to the respective Rx and Tx of the communication partner node in a cross-over wiring. Two additional UART wires, RTS (Request to Send) and CTS (Clear to Send), are optional if both communication nodes are capable of full-duplex nodes, that is, sending and receiving data simultaneously. In FIG. 7, RTS and CTS are omitted. However, RTS and CTS may be added in a modified embodiment as an additional (protruding pin/flat contact) pair on each connector side of the puzzle piece. Analogous to Tx and Rx, RTS may be connected to a protruding- or pogo-pin, and CTS may be connected to a symmetrically located flat contact (or vice versa). When two puzzle pieces (120 and 128) are connected, the RTS of one puzzle piece would be connected to the CTS of its connected peer partner. The latter configuration will allow the modified embodiment to use USART (Universal Synchronous/Asynchronous Receiver/Transmitter).

In many embodiments, the connected puzzle pieces (120 and 128) only need to communicate occasionally, such as immediately subsequent to being connected. Therefore, more than one UART interfaces corresponding to the connectors may be multiplexed in the same UART chipset inside a puzzle piece. Any other peer-to-peer serial communications protocol other than UART can be employed for two connecting puzzle pieces (120 and 128) to communicate with a connector pin assignment identical or similar. For example, legacy communications protocols such as RS-232 can be readily implemented in the configuration represented by FIG. 7, as can RS-485 (which can also be operated in peer-to-peer mode), communications protocols similar to the latter, or customized communications that make use of two wires, a transmitter (Tx) and a receiver (Rx) wire, in each connector. Examples of the latter are customized “bit-banging” protocols, or “bit-banging” simulating standard communications protocols, where communications are fully controlled by transmissions controlled down to the bit level in software.

In one embodiment, the VCC connections (108a, 114a, 108b, and 114b) are only needed, in which the puzzle pieces (120 and 128) have a power connection, such as to share power among connected puzzle pieces (120 and 128) to avoid individual pieces depleting their battery charge at uneven rates. In one embodiment, the GND connection (104a, 106a, 104b, and 106b) may still be needed for serial communications, in which the serial communications protocol is not isolated. In isolated configurations, that is, if two communications ports do not share the same ground, the GND connection is not needed. Isolated connections are part of strategies to protect connected puzzle pieces (120 and 128) from failures in one node damaging connected nodes by helping avoid high voltages relative to a local ground, with the tradeoff, however, of reduced efficiency and higher component costs. Therefore, embodiments that prioritize manufacturing costs will aim at providing a ground connection between connected puzzle pieces (120 and 128), especially as it is needed anyway for the puzzle pieces (120 and 128) to exchange stored battery power.

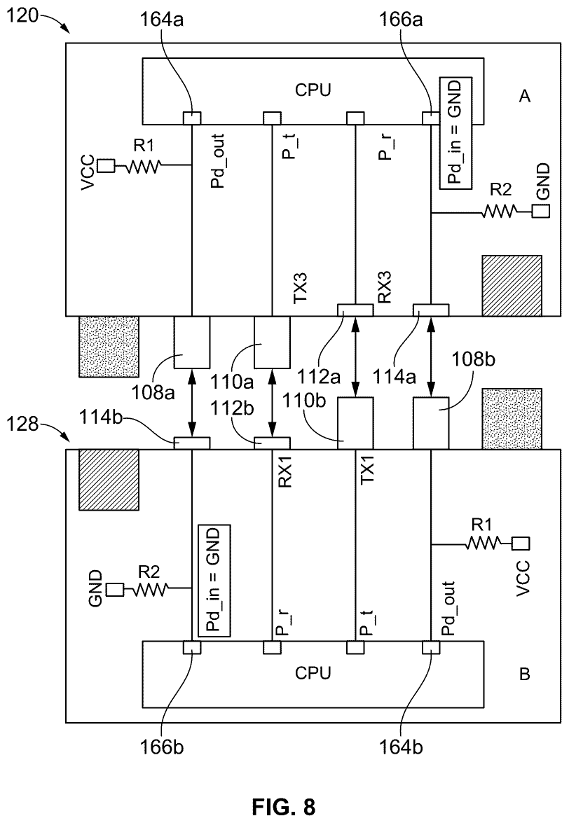

Referring to FIG. 8, a possible design of the electronics detecting the connection of two puzzle pieces (120 and 128), prior to connection is illustrated. In some embodiments, the puzzle pieces (120 and 128) will detect their connection through the Tx- and Rx-wires, for example by the puzzle pieces (120 and 128) regularly sending out test pulses through the peer connections. In other embodiments, the connection to another puzzle piece can be detected without sending test pulses through the peer communications connection (Tx, Rx). The avoidance of frequent test pulses through the communications pins will conserve power. Further, the reduced number of electrical connections will conserve connector pins, which are a significant component cost factor. The roles of the Rx- and Tx-pins are the same as outlined in FIG. 7. The RX1 pin 112b or the receiver contact on side 1 of the second puzzle piece 128, connects with the TX3 pin 110a, or the transmitter pin on side 3 of the first puzzle piece 120; and TX1 pin 110b or the transmitter pin on side 1 of the second puzzle piece 128, connects with the RX3 pin 112a, or the receiver contact on side 3 of the first puzzle piece 120.

In FIG. 8, prior to connecting the puzzle pieces (120 and 128), the VCC pin (108b and 114b) of the second puzzle piece 128 is opposite the GND contact (104a and 106a) of the first puzzle piece 120, and vice versa. In one embodiment, the circuitry is built into the puzzle pieces (120 and 128), which equalizes the voltage on at least one of the (VCC pin-GND contact) pairs upon connection. The voltage equalization is detected through other circuitry, or the same circuitry, in the puzzle pieces, providing an energy-efficient way of detecting the connection status of the puzzle pieces (120 and 128).

In an example embodiment, the circuitry that detects the connection status of two puzzle pieces (120 and 128) is shown in FIG. 8. Prior to connecting, the far-right positioned connection 108b in the second puzzle piece 128 (in the embodiment shown a protruding, or “pogo”-pin) is connected to a digital output pin 164b (for example, as it is readily configurable in microcontrollers). In one embodiment, the digital output pin 164b is initially set to logical “true” in software, and is “pulled high”, that is, connected to the voltage rail “VCC”, that defines logical “true”, via a resistor R1. The far-left positioned connection or a flat or slightly recessed contact 114b in the second puzzle piece 128 is connected to a digital input pin 166b that is “pulled low”. In one embodiment, the digital input pin 166b is connected to signal ground via another resistor R2. Typically, R1 and R2 are in the 10 k (2 range or higher. In an embodiment, a measurement of the voltage between the far-right and far-left positioned contacts prior to connecting the puzzle pieces (120 and 128) will yield VCC in both puzzle pieces (120 and 128), which is an indication of unconnected status. Since the digital output pins (164a and 164b) are pulled to VCC, the indication is also presented by reading logical “false”, or GND, in the digital input pins (166a and 166b).

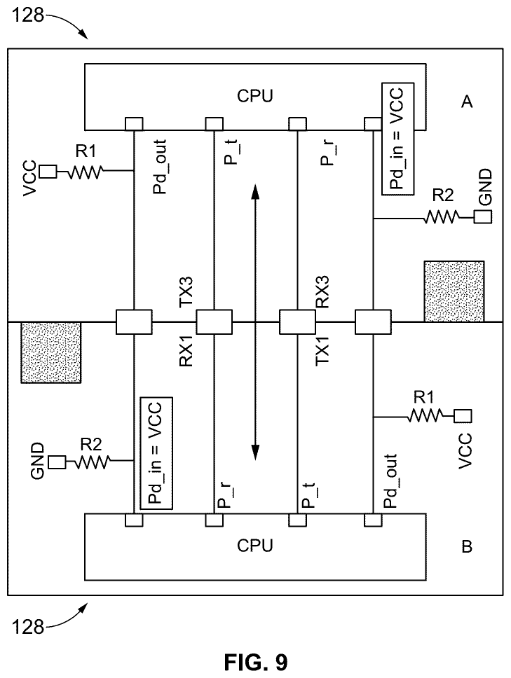

Referring to FIG. 9, a possible design of the electronics detecting the connection of two puzzle pieces (120 and 128), after connection, is illustrated. In one embodiment, the digital input pins 166 on both puzzle pieces (120 and 128) are pulled to VCC, so that the voltage measured between the digital output pins (164a and 164b) and digital input pins (166a and 166b) in both puzzle pieces (120 and 128) is zero, which is equivalent to reading logical “true”, or VCC, in both digital input pins (166a and 166b). Hence, a “true” reading in the digital input pin is an indication of the puzzle pieces being connected. Once the puzzle pieces (120 and 128) are disconnected again, the digital inputs will revert to “false” again. In embodiments in which a common ground for serial communication is needed, that common ground can be provided by the invention as shown in FIG. 9 via a shared VCC voltage rail in both puzzle pieces (120 and 128). In some embodiments, the puzzle pieces (120 and 128) shall be able to exchange power to equalize the battery charge state throughout a connected puzzle set, energy can also be exchanged through power harvesting through the data transmission/receiver pins (112a, 114a, 112b, and 114b).

In some embodiments, the prior to connection and immediate post connection configuration of two puzzle pieces (120 and 128), multiplexing circuits are included in the puzzle pieces (120 and 128) which can convert the logical input and output pins in each puzzle piece (120 and 128) to a power supply port. In one embodiment, one connected digital in/out pair is converted to GND, and the complementary connected digital in/out pair is connected to VCC supplied by the battery circuit. When power exchange is no longer needed, or when the puzzle pieces (120 and 128) are disconnected again, the multiplexing circuit reverts to the configuration shown in FIG. 9.

The connection mechanism between puzzle pieces (120 and 128) is not limited to a specific number of wired connections. In some embodiments, any combination of connection terminals may be used in a connector in which complementary connector functions are arranged symmetrically with respect to the center of a connecting surface. “Complementary”, in this context, defines a connection terminal in one puzzle piece needing to be in contact with its complementary equivalent connection terminal from the connecting puzzle piece, wherein complementary connection terminals also have complementary mechanical functions (e.g., male/female connectors; or pogo pins/flat contacts). However, the connectors utilized do not need to be complementary for a useful embodiment of the invention. For example, some sides of puzzle pieces (120 and 128) may be equipped with connectors with only protruding, or “pogo”, or similar pins, whereas other sides may be equipped with recessed or flat connectors, wherein only sides with protruding/“pogo” connectors of one puzzle piece 120 can mate with sides with recessed/flat connectors on another puzzle piece 128.

In some embodiments, other electrical connection mechanisms may not rely on complementary connectors, but on two identical or similar connecting elements forming an electrical connection. For example, two identical spring-loaded contacts with flat surfaces form a connection when puzzle sides are pushed together. The connections with both the top and bottom orientation of the display screen are possible, in which case the assignment of transmitter and receiver pairs will be managed upon connecting dynamically.

In some embodiments, mechanical or magnetic connection elements may double as data, ground, or power pins. In some embodiments, the role of providing a force-resisting separation between puzzle pieces (120 and 128) may be assumed by different connector elements as the role to provide electrical connection for data and power exchange. In some embodiments, power is exchanged between the connected puzzle pieces (120 and 128) by harvesting power from the data connection terminals TX and RX. In other embodiments, tasks of signal and power exchange may be completely separated.

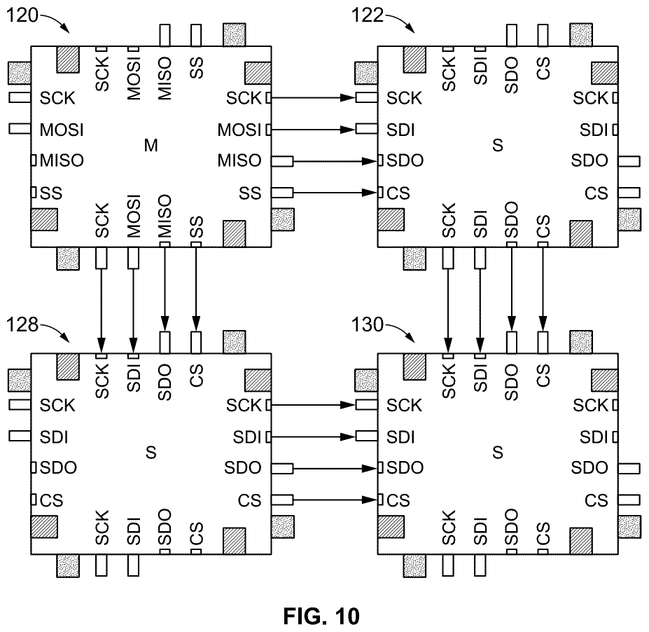

Referring to FIG. 10, the puzzle pieces (120, 122, 128, and 130) with a possible connector configuration for the exchange of data when being connected, for communications protocols other than equal peer-connections are illustrated. The data connection options among connected puzzle pieces (120, 122, 128, and 130) are not limited to peer connections. In some embodiments, the data connection is facilitated by serial connection protocols in which some puzzle pieces (120, 122, 128, and 130) assume a privileged position, which is traditionally referred to as “Master/Slave” protocols, such as SPI, I2C, or similar proprietary protocols, or similar protocols. For example, “M” denotes a “Master”, or privileged control puzzle piece, and “S” denote multiple “Slave” puzzle pieces. Depending on the limitations of the serial protocols, there may be a limited number of “S” puzzle pieces for each “M” puzzle piece, potentially resulting in puzzle sets with more than one “M” node. In other embodiments, there may be only one “M” node for an entire puzzle set.

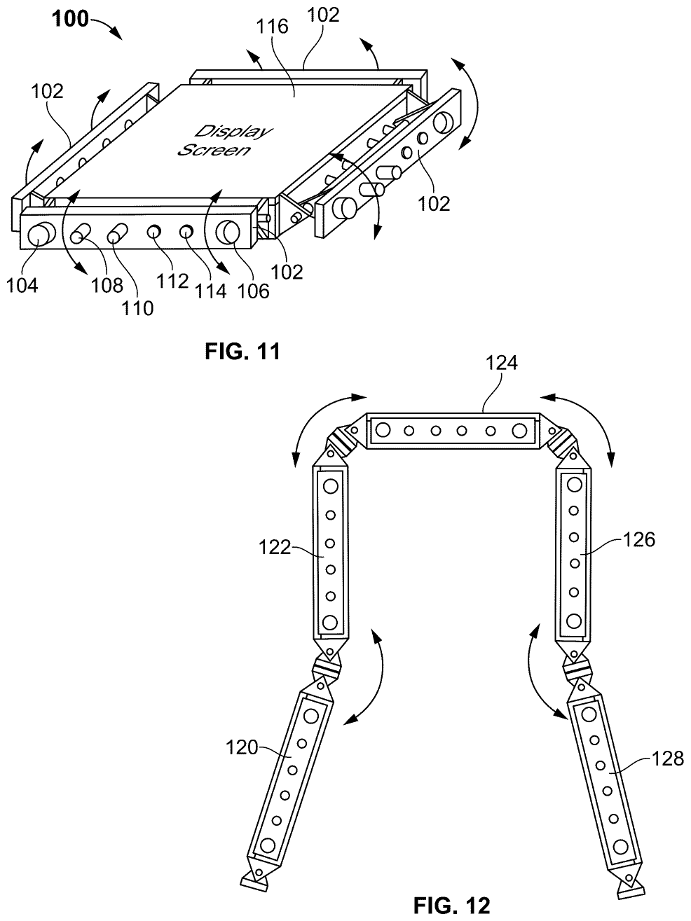

All embodiments of the invention presented up to this point resulted in substantially flat, two-dimensional (2D) images and patterns with rigid connectors aligned with at least one of the surfaces that is perpendicular to the display screen of the puzzle piece. However, there are embodiments of the invention with puzzle pieces that offer options to build three-dimensional (3D) structures enabled by connectors that are mounted on elements that are not rigidly attached to the puzzle piece, but are able to pivot around an axis attached to the puzzle piece as exemplified by FIG. 11.

Referring to FIG. 11, a cuboid puzzle piece 100 with reconfigurable images on the display screen 116 with connectors 102 with adjustable angles for 3D puzzle applications is illustrated. The connection elements 102 on the connectors 102 may include mechanical connection elements (104 and 106) and/or electrical connection elements or contacts (108, 110, 112, and 114), with functions and relative positions of protruding versus recessed mechanical connectors, as well as protruding- or “pogo”-pins versus flat or recessed contacts, substantially the same or similar to embodiments such as shown in FIG. 7 or 8 and varying within the same configuration range. Flexible conductors such as wires or flexible Printed Circuit Boards are used to maintain electrical contact between the connection elements and the connecting elements. The connecting elements 102 allow movement around an axis in or close to the plane of the display screen 116 and along the edge of the puzzle piece 100. It also covers any mechanical connection that satisfies the indicated freedom of motion, including but not limited to axles through plain bearings, rolling element bearings such as ball bearings or roller bearings, and fluid bearings; at least one hinges per connector; flexible beams of material with memory such as made of rubbery materials which can bend; flexible beams of bendable material with or without memory.

Referring to FIG. 12, an example of a three-dimensional reconfigurable puzzle built using multiple puzzle pieces (120, 122, 124, 126, and 128) according to another embodiment, is illustrated. Each of the puzzle pieces (120, 122, 124, 126, and 128) can connect with up to four other puzzle pieces with compatible connectors 102 so that several puzzle pieces can comprise elaborate 3D structures. The puzzle pieces 120 through 128 are about to form a tower-like structure that is open on two sides (“front” and “back”), which can be closed by adding additional puzzle pieces in the front and back. The composite three-dimensional (3D) puzzle pieces can be configured to display content with the same variability as two-dimensional (2D) embodiments.

One difference between 3D and 2D embodiments in terms of full coverage is that gaps between display screens are unavoidable as long as the size of the display screen is limited to the main enclosure of each puzzle piece not including the connector and hinge mechanisms. In some embodiments, the incomplete coverage is addressed by installing larger display screens that cover the hinged connector mechanisms. The latter approach will address gaps in the coverage of 2D sections of a 3D puzzle set. However, angles or corners such as in the connection between the two puzzle pieces (122 and 124) still show gaps in full screen coverage even with display screen sizes. In some embodiments, this is addressed by increasing the size of the display screens even further, to allow for full coverage of angles or corners of 90 degrees or even larger angles. The latter requirements require flexible display screens to allow for connecting puzzle pieces or angles smaller than the maximum corner angle the display screens are designed to cover. Such flexible or “bendable” display technology is now readily available for displays in the class of paper-like displays.

The 3D example embodiments, and the previous 2D example embodiments, lend themselves to the application of paper-like displays for the display screen. This does by no means represent a limitation of 3D embodiments to paper-like displays, and the entire range of display technologies is considered for the 2D and 3D embodiments shown so far, as well as in the rest of this document. However, paper-like display technology is attractive as a non-volatile display option that conserves battery power in 3D as well as in 2D embodiments.

In some embodiments of both 2D or 3D capable options, the images displayed on the puzzle pieces' display screens are designed by a Content Designer (as defined above) and the images or copies thereof are transferred to the puzzle pieces, and the images do not change while the Learners or Users (as defined above) assemble the puzzle pieces or otherwise handle the puzzle pieces or the assembled puzzle set, until the Content Designer prepares and transfers a new set of images. In other embodiments, multiple images are prepared by the Content Designer and transferred to at least one puzzle piece among a puzzle set, wherein the multiple images are displayed successively in time as a series of images or as a continuous movie. The latter successive display in time can either follow a predefined sequence set by the Content Designer or influenced through action by the Users.

In both the 3D and 2D embodiments presented so far, the focus was on the display of images on display screens. In addition to displaying one or multiple (in a time series) images, some embodiments of the invention include input options such as through graphical input devices. These graphical input devices may overlay or be integrated with the display screens. Examples of graphical input devices are surface capacitive touch screens, projected capacitive touch screens, resistive touch screens, surface acoustic wave touch screens, optical imaging touch screens, and infrared touchscreens. Resistive touchscreen technology is the most wide-spread due to low cost and low power consumption, which is most compatible with a battery-powered product consisting of multiple, in some cases many, pieces. However, other technologies capacitive or acoustic tend to be more durable and may be the preferred choice in some therapy or education settings. Touchscreens are actuated either with an extremity (body part such as a finger), with a stylus (pen-shaped actuator), or any other mechanical object. Some touchscreen technologies do not work with some types of actuators; for example, capacitive touchscreens are not compatible with actuators made of materials with low permittivity, and other touchscreen technologies are not compatible with sharp stylus.

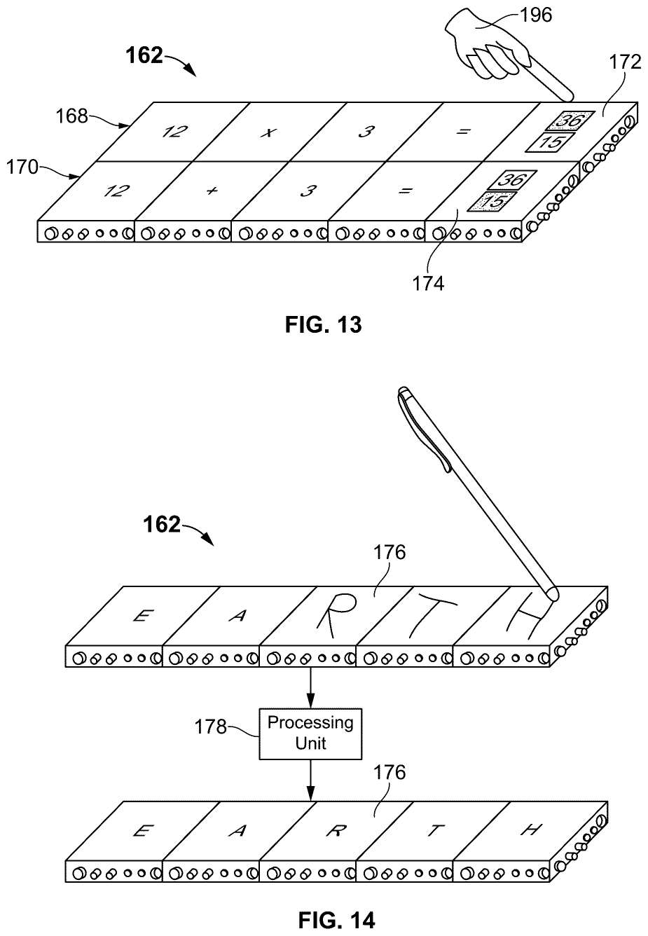

Referring to FIG. 13, a learner 196 interacting with a flat assembled puzzle set 162 with some or all puzzle pieces equipped with touchscreens is illustrated. The puzzle set 162 may contain at least one puzzle piece with a touchscreen which allows input from the user 196, either on the individual puzzle piece, or if the puzzle set 162 is partially or fully assembled. For example, the user 196 selects the appropriate answers to two simple math problems (168 and 170) by selecting the correct answer among multiple choices on two puzzle pieces with touchscreens (172 and 174). In the embodiment shown, the Content Designer will prepare the possible answers. This is merely a simple demonstrative example, and the types of problems useful in education, childhood development, therapy, and play opened up by the possibility of User input through a touchscreen cover all the types of topics and themes. In many embodiments, it permits more complex touchscreen inputs than one or multiple point contacts, such as drawing or writing motions.

Referring to FIG. 14, a learner 196 interacting with a flat assembled puzzle set 162 with some or all puzzle pieces 176 equipped with touchscreens, is illustrated. The puzzle piece 176 is equipped with a processing unit 178 to recognize patterns on the touchscreen, with a simple language acquisition problem. The touchscreen input is processed by the processing unit 178, wherein the touchscreen is attached inside the puzzle piece 176. In many embodiments, the processing unit 178 transmits control signals to the electronic display that is underneath of or integrated with the touchscreen and directs the electronic display to show patterns in response to writing or drawing motions of a finger, stylus, or tool on the touchscreen. In some embodiments of configurations, these patterns displayed may trace the writing- or drawing motion on the touchscreen. An illustrative example is shown in the upper half of FIG. 14. The example can be generalized to many other applications, including, but not limited to, math problems, themes out of Users' personal lives, art, engineering, computer science and programming, and any other topic or theme.

In some embodiments, the processing unit 178 performs machine learning or artificial intelligence (ML/AI) algorithms on the touchscreen input. Depending on the embodiment or the configuration of the embodiment, the objective of the ML/AI algorithms may be classification in some embodiments/configurations and/or quantitative evaluation in other embodiments/configurations. Algorithms to interpret the touchscreen input include image classification algorithms, neural network-based algorithms for processing written symbols that can be labeled by one of a finite number of labels, or any other image recognition algorithms. The labels may represent letters, numbers, logograms, hieroglyphs, geometric patterns, technical symbols such as engineering symbols, and more abstract object classifications, or any other finite set of classifications. The neural network-based algorithms include, but are not limited to, convolutional neural networks, which are a subset of “deep learning” neural network algorithms. Other than classification, quantitative analysis may be conducted which may include regression analysis to extract a quantitative number, or quantitative analysis may run along classification algorithms to evaluate a quality metric for symbols generated by the Users. The quality metric may contribute to grades or progress indicators in learning-, development-, education-, and therapy settings.

An example for classification algorithms applied to the user input is shown in FIG. 14, where the response to a simple language task of completing a dictionary word to be written on the touchscreen by the user 196 is interpreted as a series of letters from the Latin alphabet. In some embodiments, the number corresponding to the correctly interpreted symbol may be displayed, in other embodiments, the classification interpreted by the processing unit 178 is stored and further processed without displaying it, and in yet other embodiments, the classification result is both stored and displayed. The processing unit 178 may be integrated into one or more of the puzzle pieces, such as 176, or may be integrated into another puzzle piece, or may be integrated into a system that is external to the puzzle set or partial puzzle set (such as a remote server or a PC, tablet, smartphone, or other computing device exchanging data with the puzzle set). Embodiments such as illustrated in FIG. 14 can be readily and gainfully generalized to non-Latin writing systems, some of which can based on more complex symbols.

The puzzle pieces 176 can also be used to make free-hand drawings on a partially or fully assembled puzzle sets. The drawings on the puzzle sets, are further processed using image classification and interpretation schemes. The touchscreen concept can be generalized to 3D embodiments on at least the same applications scope as 2D embodiments, enabling the users 196 to interact with fully or partially assembled 3D puzzles, wherein at least one puzzle piece among the 3D puzzles may contain a touchscreen. In some embodiments, further processing might take place by processing units 178 in the puzzle pieces with touchscreen, or external to it.

In some embodiments, puzzle sets may contain at least one puzzle piece that contains a haptic feedback mechanism on at least one surface of the puzzle piece. In most of the latter embodiments, the content editor is able to configure, in response to input from the touchscreen; or other sensors; or following a time sequence; or input from the user 196, the output of the haptic feedback actuator; or the display on at least one display screen on at least one puzzle piece; or any other output or data transmission to an external device that can be initiated by at least one puzzle piece.

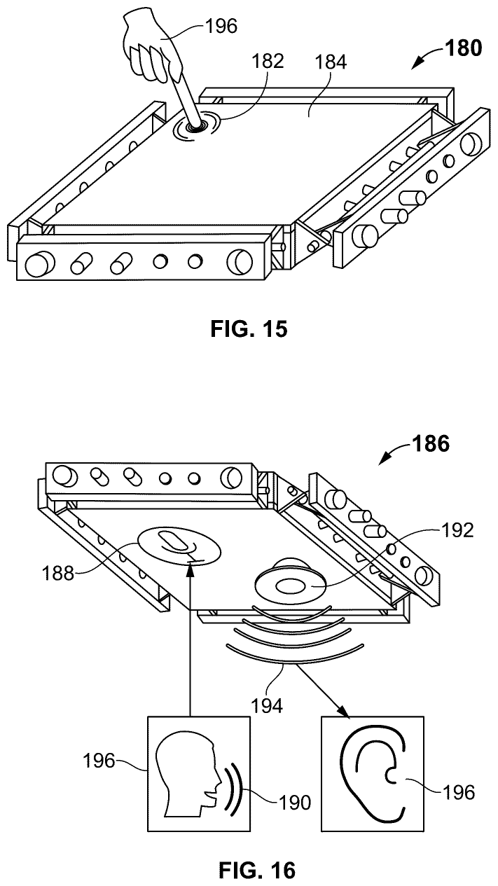

Referring to FIG. 15, a learner 196 interacting with a puzzle piece 180 equipped with haptic feedback through vibrations is disclosed. The haptic feedback mechanism may induce vibrations 182 on at least one point of a surface 184 which can be perceived by touching the at least one point. The finger or mechanical device transmitting vibrations 182 is touching a haptic feedback surface 184 on the puzzle piece 180, where at least one point is configured to provide haptic feedback through vibrations. The vibration actuators may rely on electro-mechanical transducers such as piezoelectric transducers on at least one point of the surface 184, or an array of piezoelectric actuators on the surface 184. In some embodiments, piezoelectric vibrations may be induced in ultrasonic frequency ranges or other frequencies. The vibration actuators may also rely on other types of electro-mechanical actuators, such as embodiments based on electromagnets or permanent magnets in electromagnetic fields.

In other embodiments, the haptic feedback mechanism relies on actuators creating relief structures or controlling the perceived surface roughness on at least one surface of the puzzle piece 180 with haptic feedback. Among the latter, a relief map or map of varying surface roughness or friction can be created on the surface 184. Examples of technologies for the controlled manipulation of surface roughness include, but are not limited to: electromechanical actuators, wherein permanent intermediary displacement is induced instead of vibration frequencies; microfluidic actuators in which a liquid is used to create relief structures or rough surfaces on the at least one surface with haptic feedback; pneumatic actuators in which a gas is used to the same effect as the fluid in the latter option.

In yet other embodiments, the haptic feedback mechanism relies on actuators that directly stimulate touch senses on extremities such as a finger, for example, the tip of an index finger, wherein the perceived stimulation is different from simply touching the surface 184. Mechanisms for the direct stimulation include but are not limited to: sets of at least two electrodes on, and protruding through, at least one surface of a puzzle piece with haptic feedback which maintains at least two different voltage levels, wherein the voltage levels may not vary in time, or may vary with an adjustable and/or variable frequency, wherein the magnitude of the voltage level and the frequency may be adjusted to initiate targeted modified haptic perceptions in a body extremity in contact with at least two electrodes; capacitive actuators containing at least two electrodes or electrode arrays fully embedded in at least one surface of a puzzle piece with haptic feedback, wherein a voltage is applied between the electrodes with varying amplitude under constant or variable frequency excitation, wherein a modified haptic perception is induced in an extremity in close contact to the at least two electrodes through electromagnetic induction.

In some embodiments, haptic feedback actuators or other haptic feedback devices may not be located on the puzzle piece 180 but may be in contact with a body part of the user 196 while the user 196 is touching a touch screen, wherein the haptic feedback actuators are connected to the puzzle piece 180 in a manner that permits transmitting signals or commands from the puzzle piece 180 to control the haptic feedback. The User's touching actions on the touchscreen results in at least one signal or command sent from the puzzle piece 180 to the actuator in contact with a body part, permitting indirect haptic feedback. In addition to the haptic feedback technologies presented above, other haptic feedback devices include but are not limited to existing haptic user interface devices such as haptic mice, haptic gloves, force feedback actuators, and thermal feedback actuators.

Some of the aforementioned 2D or 3D embodiments with or without haptic feedback may further include sensors to measure audible sounds and actuators that generate audible sound, which permit at least one puzzle piece 180 among a set of puzzle pieces to sense speech or other sounds generated by the user 196 or by a device controlled by the user 196 and generate speech and other sounds audible by the user 196. The audible sound sensors or actuators may be either integrated into a puzzle piece or may be integrated into another device which is in contact with at least one puzzle piece 180. The audible sound sensor may be a microphone and the audible sound actuator may be a speaker or at least one earphone or at least one augmented hearing device. The sound measured by the audible sound sensor may be processed using machine learning/artificial intelligence (ML/AI) algorithms, which may include Natural Language Processing algorithms for speech recognition. In most of the latter embodiments, the Content Editor is able to configure, in response to input from the audible sound sensor; or input from the touchscreen; or input from other sensors; or User input; or following a sequence, the output of the sound actuator; or the display on at least one display screen on at least one puzzle piece or; or haptic feedback on at least one puzzle piece; or any other output or data transmission to an external device that can be initiated by the puzzle piece 180.

Referring to FIG. 16, a puzzle piece 186 equipped with an audio input and output device is illustrated. The puzzle piece 186 contains a microphone 188, which permits the user 196 to provide input to the puzzle piece 186 by generating audible sound, such as through natural language, which results in sound waves 190 traveling to the microphone 192, where they are detected and measured. In one embodiment, the same puzzle piece 186 also contains a speaker 192, which generates audible sound 194 that can be perceived by the same or other user 196. In other embodiments, only the microphone 188, or only the speaker 192 may be integrated into the puzzle piece 186, or the microphone 188 and speaker 192 may be integrated into different puzzle pieces which are in wired or wireless contact.

All embodiments of the invention allow means for data transmission to the puzzle pieces comprising a puzzle set, and many embodiments allow means of retrieving other data from at least one puzzle pieces in the puzzle set. To facilitate the data transmission and the retrieving of other data, at least one puzzle piece is connected to an external data transmitting device through a wired or wireless connection.

In some embodiments, at least one puzzle piece contains sensors that generate a significant amount of raw data, such as sound-recording devices or touchscreens, some processing of the sensor data will be conducted by a processing unit integrated into the puzzle piece. The preprocessed data requires significantly less storage than the raw data, wherein the preprocessed data may get retrieved from the puzzle piece by a data transmitting device. In some embodiments, most or all of the processing of some data will be conducted in the puzzle piece. Partial or complete processing of data in a portable- or mobile device such as a puzzle piece is in the Internet of Things (IoT) technology domain referred to as Edge Processing. Such preprocessing may comprise reducing resolutions of characters drawn on touchscreens, decoding symbols written through handwriting recognition algorithms, removing noise from recorded audio files, or decoding audio files. However, in some embodiments, no preprocessing may be conducted, and the raw data may be forwarded directly to a data transmitting device.

It is understood that the processing unit in the puzzle pieces, such as the processing unit performing the Edge Processing mentioned, will be a microcontroller in many preferred embodiments which would be manufactured most cost-effectively now, such as an ARM compatible microcontroller, or compatible with another ecosystem such as an Espressif or Microchip microcontroller. However, with ongoing miniaturization and reduced cost for a given amount of processing power, it is understood that puzzle pieces with CPUs such as those used today in personal computers, graphical processing units (GPUs), or processors with reconfigurable logic blocks such as field-programmable gate arrays (FPGAs) or hybrid microcontroller-FPGA architectures may, in the near future, be manufacturable at reasonable cost, so that the patent shall also cover embodiments with those processing units. Further, more application-specific processors originally designed for other purposes, such as digital signal processing systems (DSPs) may be repurposed for the puzzle pieces.

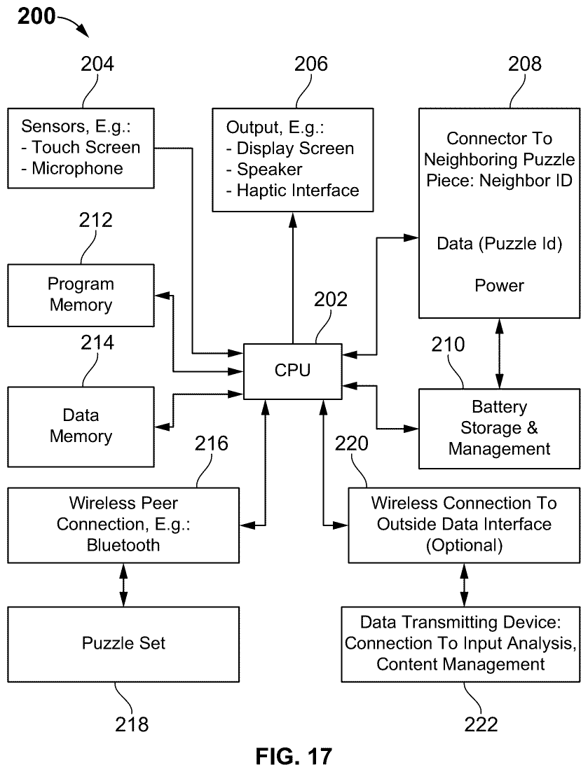

Referring to FIG. 17, a block diagram 200 of major components the puzzle piece 100 according to one embodiment is illustrated. The block diagram 200 comprises a central processing unit (CPU) 202. In many embodiments, the CPU 202 will process signals from sensors 204 integrated into the puzzle piece 100. In one embodiment, the sensor 204 may include touchscreens, sound recording devices such as microphones, or sensors that detect the action of connecting two puzzle pieces. The block diagram 200 further comprises a data output 206. The data output 206 receives data from the CPU 202, at a minimum, to at least one display screen per puzzle piece 100. In some embodiments, to other output devices such as sound generating devices (such as speakers), or haptic output devices that simulate a certain sensation of touch if an extremity of a human is in contact with at least one surface of the puzzle piece. The CPU 202 is also in contact, directly or indirectly, with the at least one (in many embodiments, four or more) connectors 208. The connectors 208 serve as a channel for transmitting data between puzzle pieces. The data is at least comprised by identifying information on which two puzzle pieces are connected and through which of their at least one connector.

In one embodiment, the CPU 202 derives power from, and controls a battery storage integrated into the puzzle pieces through a battery management system 210. In some embodiments, the battery management system 210 may transmit power to, or receive power from another puzzle piece connected through the connector 208, depending on which puzzle piece has more energy stored. In one embodiment, the CPU 202 is connected to and/or integrates program memory 212 to store computer programs to be executed. The CPU 202 is further connected to and/or integrates data memory 214. In one embodiment, the data memory 214 may include storing data from puzzle piece sensors 204, or which may include buffering data prior to output 206, or which may include storing data for wired or wireless transmission to other puzzle pieces, from among the puzzle set 218, through wireless peer connection 216, for example Bluetooth®. In some embodiments, the data memory 214 may include storing data received from wired or wireless connections from other puzzle pieces through wireless peer connection 216 from a puzzle set 218. In some embodiments, the data memory 214 may include storing data for wired or wireless transmission to devices not included in the puzzle set through a wired or wireless data connection through an outside data interface 220 to a data transmitting device 222, or which may include storing data received from devices not included in the puzzle set through an outside data interface 220 from a data transmitting device 222.

In some embodiments, the data transmitting devices 222 may include, but are not limited to, data transmitting devices such as User devices or other communication devices. The data interface 220 may be embodied as a wired or wireless connection to the appropriate data transmitting device 222. The data transmitting device 222 may transmit content for visual and audio output, or program and configuration files, to the puzzle pieces, or it may retrieve sensor input or data processed from sensor input to be analyzed external to the puzzle set 218. The wired or wireless connection 216 may include, but is not limited to, the wired or wireless peer connection among the puzzle pieces comprising the puzzle set 218.

While the block diagram 200 includes data interfaces 220 to exchange data with other puzzle pieces 216, and data interfaces 220 to exchange data with data transmitting devices 222 outside the puzzle set 218, it is understood that, in some embodiments, not every puzzle piece may be equipped with both data interfaces. In some embodiments, within a puzzle set 218, at least one among a privileged class of puzzle pieces may be equipped with the data interface 220 and exchange data with external devices. In other embodiments, the wireless data interfaces (216 and 220) may be identical, with the external data transmitting device essentially participating in a peer mesh network of puzzle pieces.

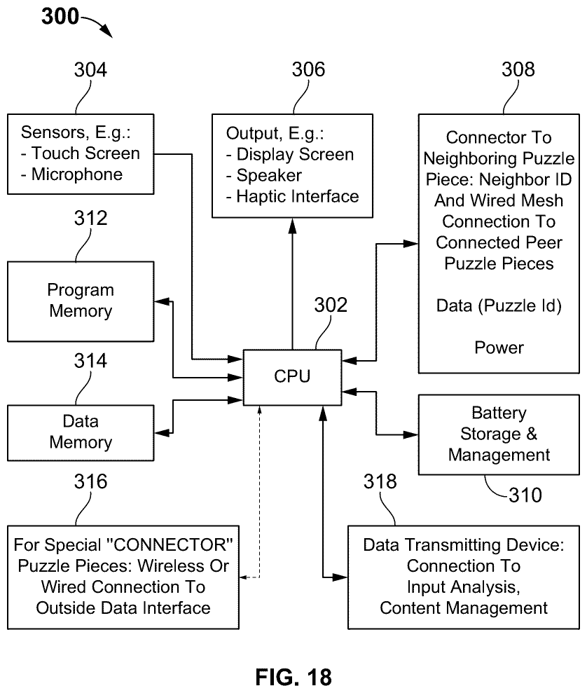

Referring to FIG. 18, a block diagram 300 of major components of a puzzle piece 100 according to another embodiment is illustrated. At least some puzzle pieces within a puzzle set 322 can only exchange data while they are connected. The block diagram 300 comprises a central processing unit (CPU) 302. In many embodiments, the CPU 302 will process signals from sensors 304 integrated into the puzzle piece 100. In one embodiment, the sensor 304 may include touchscreens, sound recording devices such as microphones, or sensors that detect the action of connecting two puzzle pieces. The block diagram 300 further comprises a data output 306. The data output 306 receives data from the CPU 302, at a minimum, to at least one display screen per puzzle piece 100. In some embodiments, to other output devices such as sound generating devices (such as speakers), or haptic output devices that simulate a certain sensation of touch if an extremity of a human is in contact with at least one surface of the puzzle piece. The CPU 302 is also in contact, directly or indirectly, with the at least one (in many embodiments, four or more) connectors 308.

The connectors 308 serve as a channel for transmitting all the peer-to-peer data exchanged among puzzle pieces, essentially forming the backbone of a wired mesh network. The data still includes identifying information on which two puzzle pieces are connected and through which of their at least one connectors.

In one embodiment, the CPU 302 derives power from, and controls a battery storage integrated into the puzzle pieces through a battery management system 310. In some embodiments, the battery management system 310 may transmit power to, or receive power from another puzzle piece connected through the connector 308, depending on which puzzle piece has more energy stored. In one embodiment, the CPU 302 is connected to and/or integrates program memory 312 to store computer programs to be executed. The CPU 302 is further connected to and/or integrates data memory 314. In one embodiment, the data memory 314 may include storing data from puzzle piece sensors 304, or which may include buffering data prior to output 306. In some embodiments, the data memory 314 may include storing data received from wired or wireless connections from other puzzle pieces through wireless peer connection or data interface 316. In some embodiments, the data memory 314 may include storing data for wired or wireless transmission to devices not included in the puzzle set through a wired or wireless data connection through an outside data interface to data transmitting device 318 for input analysis and content management.

The data interfaces are replaced, to the puzzle set and to data transmitting devices external to the puzzle set, respectively, there is only one optional wired or wireless data interface 316. The wireless data interface 316 is included in at least one puzzle piece among the puzzle set. In many embodiments, the data interface 316 is only included in special connector puzzle pieces capable of exchanging data with an external data transmitting device. The external data transmitting device 318 assumes the same functions as defined in the application scope for device.

The data transmitting devices external to the puzzle set described above serve as conduits for the transmission of content generated by the Content Designer to the puzzle pieces, as well as conduits for sensor input, or processed sensor input data, to be retrieved from the puzzle pieces and transmitted to a Content Analyst.

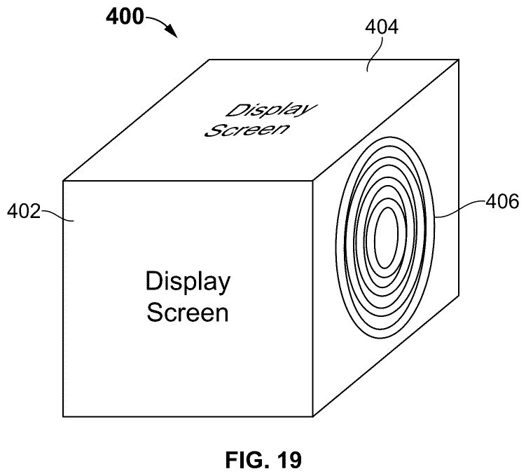

Referring to FIG. 19, a puzzle piece 400 with two visible display screens (402 and 404) and one side with a concentric-electrode connector (406) on other side is illustrated. In some embodiments, the puzzle piece 400 has a flat cuboid shape with the display screen (402 and 404), such as a paper-like display or any other display screen, on at least one of the two larger faces of the flat cuboid. In many embodiments, the puzzle piece 400 may have different shapes that allow more than one or two display screens (402 and 404).

For example, FIG. 19 shows a cuboid with multiple display screens (at least 402 and 404, but also potentially any of the sides not specifically shown”). The other side does not include a display screen, but a connector 406 which permits the puzzle piece 400 to mechanically and/or electrically connect to another puzzle piece. In some embodiments, the puzzle piece 400 may include, but not limited to, a cube or a cuboid shape. In some embodiments, the display screen (402 and 404) may be, but not limited to, squares, rectangles, or any other shape that matches a connecting puzzle piece on at least one of the sides containing connectors 406. The other sides of the puzzle piece 400 may either contain display screens or connectors to neighboring puzzle pieces. The puzzle sets consisting of puzzle pieces similar to, but potentially with different functionalities (e.g., display versus connector) on the cuboid sides compared to FIG. 19 may contain pieces with one through five connectors, however, they shall contain at least one connecting side and at least one display screen.

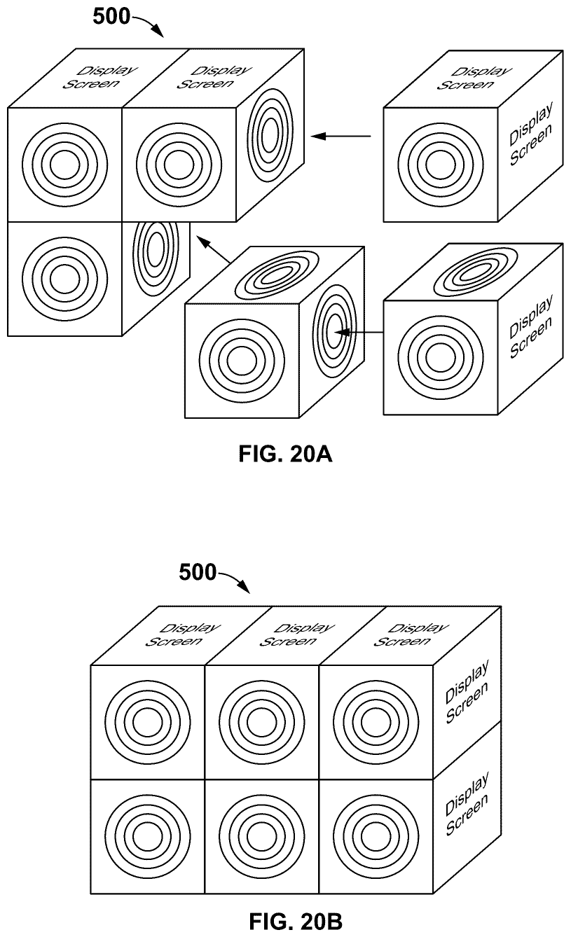

Referring to FIGS. 20A-20B, a number of puzzle pieces with taller cuboid shapes connected to form a complex 3D structure 500, is illustrated. The puzzle sets consisting of such puzzle pieces may be assembled into larger 3D shapes 500. The shapes can be created using, but not limited to, regular polygons or any complexity.

According to the present invention, the reconfigurable puzzle 100 is an innovative and intelligent multisensory product that strengthen and gauge individual's mental faculties. In one embodiment, the reconfigurable puzzle 100 is used for users with cognitive challenges, from ageing community (those at risk of dementia) to the very young (e.g., pediatric autism). Further, the reconfigurable puzzle 100 reduces inequities by empowering primary care providers and educators to offer specialist-level therapies.

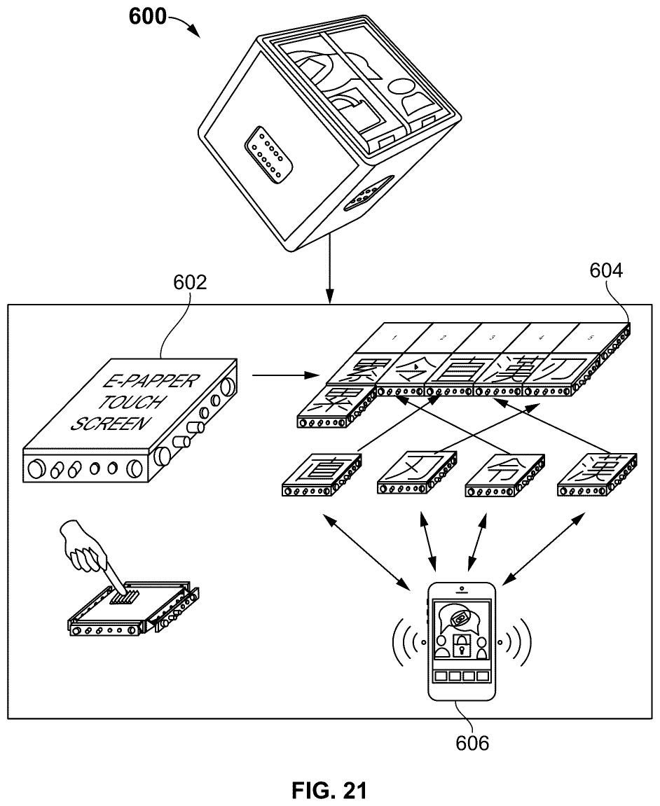

Referring to FIG. 21, an example 600 illustrating unique features of a reconfigurable puzzle 600 with proven clinical benefits. In one embodiment, the reconfigurable puzzle 600 is a single platform for a range of cognitive tests and non-invasive therapies for dementia. It can be administered by any medical provider, eliminating specialist care bottlenecks and months-long wait lists. It also helps to avoid high-impact therapies, by improving quality of life for millions while keeping healthcare affordable.

In one embodiment, the reconfigurable puzzle 600 is multi-sensory, interactive, and haptic tool. The reconfigurable puzzle 600 is a physical device, which is more beneficial than an application software. In one embodiment, the reconfigurable puzzle 600 comprises one or more puzzle pieces 602 having multiple universal connectors or connecting elements 604. Multiple puzzle pieces 602 are connected together using the universal connectors 604 provided at their sides. In one embodiment, the multiple puzzle pieces 602 are connected using remote content configuration. In one embodiment, the remote content configuration is achieved using a user device 606. In some embodiments, the user device 606 may be, but not limited to, a mobile phone, a smart phone, a laptop, a desktop, a personal computer, or any other electronic communication device.

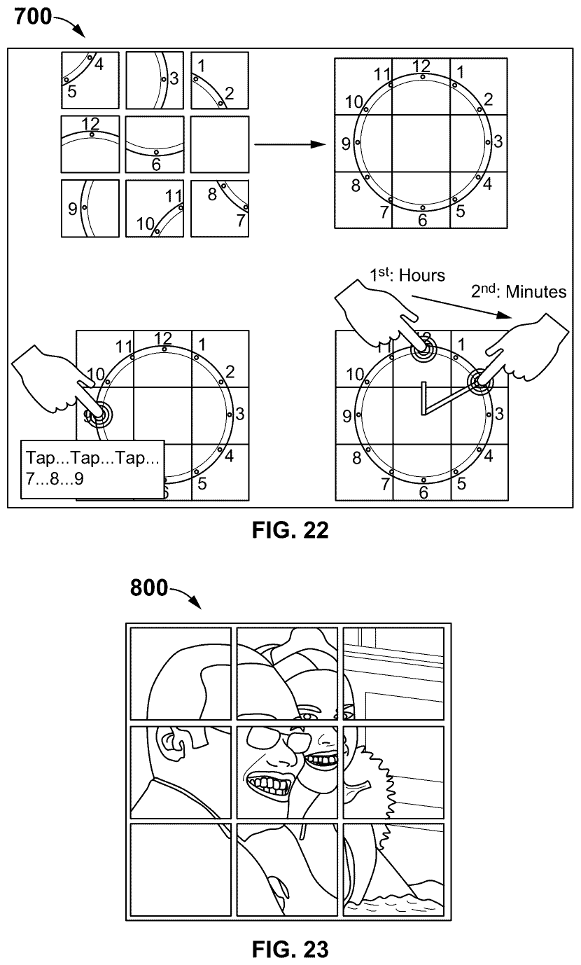

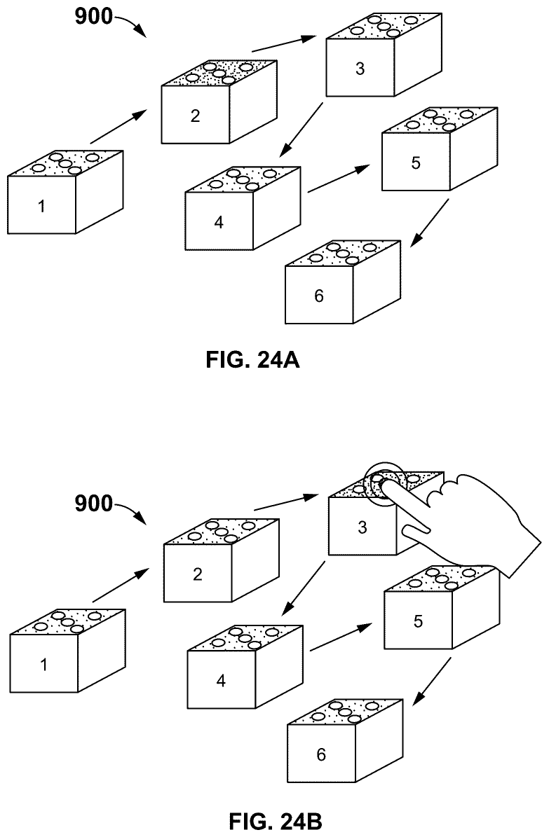

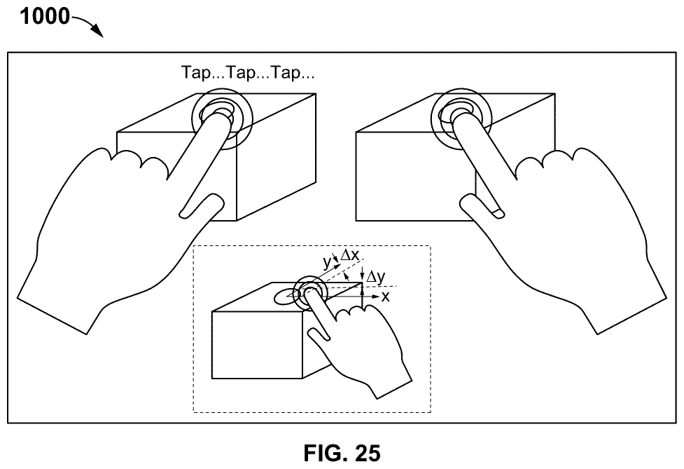

Referring to FIGS. 22-25, various test methods are disclosed. FIG. 22 exemplarily illustrates a cognitive test 700. The cognitive test 700 is Montreal Congnitive Assessment (MoCA). The cognitive test assist users to assemble the puzzle pieces with different images in a correct configuration. FIG. 23 exemplarily illustrates a finger-tapping test 800. FIGS. 24A-24B exemplarily illustrates a corsi's block tapping test 900. FIG. 25 exemplarily illustrates a personalized assembly test 1000.

In one embodiment, the reconfigurable puzzle includes a method that includes some or all of the following features: at least two reconfigurable puzzle pieces connected out of a set with electronic display screens, such that the display screens align and comprise a composite image that is part of a larger composite image. Each of the at least two reconfigurable puzzle pieces is assigned a unique identifier among all puzzle pieces out of the set. The connection between each two puzzle pieces takes place through at least one mating connector per puzzle piece located on at least one surface of each reconfigurable puzzle piece that does not contain a display screen. In one embodiment, each mating connector includes at least two electrical connectors, each of which can form a conductive pathway with another connector if the connector is mated with a connector on another puzzle piece.

In one embodiment, the mating connectors are held together by mechanical or magnetic means or both. The mating of connectors results in at least two conductors in one connector each forming an electrical connection with one of at least two conductors in the other connector. In one embodiment, each reconfigurable puzzle piece contains a processing unit that can receive and transmit data through at least one wired interface with at least two wires per wired interface. In one embodiment, at least one wired interface is connected to at least two conductors in the mating connectors of each puzzle piece.

In one embodiment, the processing element in each puzzle piece detects when a connector is mated with the connector of another puzzle piece. Upon detection of a connection event, processing elements of two puzzle pieces now connected exchange their respective unique identifiers via the at least one wired data interface. In one embodiment, each mating connector includes a means to store electrical energy to power the electronic display screen and processing unit when the puzzle piece is not connected to a power source, wherein the means to store electrical energy can be replenished by connecting it with a voltage source. Each mating connector includes at least one electrical connection that is connected to a local electrical ground within the connector's puzzle piece, and another electrical connection that is connected to a voltage other than ground.

Upon connectors mating, electrical connections connected to local grounds of the two connected puzzle pieces involved are connected together, and other electrical connections connected to voltages other than ground are connected together. If the means to store electrical is less discharged in one puzzle piece compared to the puzzle piece it is connected to, electrical energy is transferred from the puzzle piece that is less discharged to the puzzle piece that is more discharged via the connected grounds and connected voltages other than ground in each connector. In one embodiment, all of the set of at least two puzzle pieces are connected together by mating connectors, wherein the set of at least two puzzle pieces has at least one predetermined correct configuration in which the puzzle pieces are connected together, in which each puzzle piece is connected, through mating connectors, to puzzle pieces with specific unique identifiers. In one embodiment, the set of puzzle pieces actuates a user interface signal on an external device that indicates successful assembly of the set, or that indicates unsuccessful assembly of the set, depending on which condition is reached first.

In one embodiment, the reconfigurable puzzle further includes methods including some or all of the following: a person actuating at least one sensor integrated into at least one reconfigurable puzzle piece that includes at least one digital display screen displaying a segment of a static or moving image that is part of a complete static or moving image. In one embodiment, the at least one sensor and at least one display screen included in each puzzle piece are connected to at least one processing unit that controls which image is displayed on any connected display screen. In one embodiment, the processing unit in the puzzle piece in which the at least one actuated sensor is integrated is connected through wired or wireless communication interfaces to at least one other processing unit that is connected to at least one other display screen that shows another segment of the complete image. In one embodiment, the actuation of at least one sensor results in a modified image segment displayed on at least one digital display screen of the same puzzle piece the sensor is integrated in, or results in another modified image segment displayed on the at least one other display screen connected to the at least one other processing unit.

In one embodiment, the reconfigurable puzzle further includes methods for some or all of the following features: a person actuating an audio sensor connected to a first processing unit on which audio recognition software is running that encodes audio signals generated by a user. The specific encodings of audio signals result in the generation on instructions to modify a segment of a complete static or moving image. The first processing unit is connected to multiple other processing units. In one embodiment, each of the multiple other processing units is connected to at least one digital display screen that shows a different segment of a complete static or moving image. In one embodiment, the instructions result in the modified display of at least one segment of the complete static or moving image displayed on any digital display screen.

In one embodiment, the reconfigurable puzzle also includes some or all of the following features: a person actuating a touchscreen integrated into a reconfigurable puzzle piece that includes at least one digital display screen, including at least the touchscreen. The touchscreen is connected to at least one processing unit that controls which image is displayed on any connected display screen. In one embodiment, the processing unit in the reconfigurable puzzle piece in which the at least one actuated sensor is integrated is connected through wired or wireless communication interfaces to at least one other processing unit that is connected to at least one other display screen that shows another segment of the complete image. Each from among any digital display screen displays a different segment of a static or moving image that is part of a complete static or moving image. In one embodiment, the actuation of the touchscreen results in a modified image segment displayed on at least one from among any digital display screen.

In one embodiment, the reconfigurable puzzle of the present invention further includes some or all of the following 3D aspects: one or more electrical connections are established through at least two wires between at least two enclosures through a pair of mating connectors. The enclosures are shaped like prisms or nearly like prisms with the top and bottom polygon congruent or almost congruent. In one embodiment, the enclosures are substantially flat so that the thickness of the polygon is smaller than any side length of the top- and bottom polygons.

In one embodiment, at least one among the top and bottom sides of each enclosure has a display screen mounted, and the enclosure contains means to reconfigure the image displayed on the enclosures. Each display screen is controlled by a processing unit inside the enclosure, that is connected to at least one wired data interface connected to the connectors that can mate with another enclosure. In one embodiment, the wired data interface is capable of transmitting and receiving instructions, through connector once mated with another connector, for the processing unit to modify at least one of the images displayed. The mating connectors on each enclosure are one of at least one connector attached to at least one side of each prism. Each connector is attached to a side of a prism through mechanisms that allow the connector orientation to change by swiveling around an axis that is parallel to the side the connector is attached to.

With the orientation of a connector defined as the plane defined by the connector's swivel axis and the electrical connection points it establishes with a mating connector. In one embodiment, each connector plane is allowed to orient itself along a plane that is not parallel to the top or bottom of the prism-shaped enclosure it is attached to. In one embodiment, the connector on each enclosure is allowed to mate with a compatible connector that is oriented along a plane that is not parallel to the top or bottom of the prism-shaped enclosure it is attached to. In one embodiment, the connectors on two enclosures are allowed to mate while the top/bottom polygons of both enclosures are not parallel, thus allowing the construction of complex three-dimensional shapes by mating at least three enclosures with at least two connectors each.

Advantageously, the reconfigurable puzzle of the present invention is designed to provide improved education, entertainment, and therapy. The reconfigurable puzzle is used for cognitive tests and non-invasive therapies. Also, the reconfigurable puzzle is multi-sensory, interactive, and haptic tool. The physical device is proven to be most beneficial than any application software that used for education, entertainment, and therapies. Also, the reconfigurable puzzle is used for a range of cognitive tests and non-invasive therapies for dementia. Further, the reconfigurable puzzle eliminates diagnostic delay by providing primary care access to specialist-level, automated testing.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A reconfigurable puzzle for providing education, therapy, cognitive diagnostics, or entertainment, the puzzle comprising:
a plurality of electronic devices each operating as individual puzzle pieces, each of the plurality of electronic devices comprising:
a processing unit having at least one wired interface including at least two wires, the processing unit configured to transmit and receive data via the at least one wired interface;
a means to store energy in each electronic device, such as a battery or supercapacitor;
at least one electronic display screen on one side of the electronic device and in signal communication with the processing unit, the first display screen being reconfigurable to display various parts of a composite image;
a touchscreen overlaid, or integrated with, at least one of said electronic display screens in at least one electronic device from among the puzzle, wherein the touchscreen is in signal communication with the processing unit, or a dedicated touchscreen processing unit in signal communication with the processing unit; and
at least one mechanical connector disposed on at least one of a plurality of sides of the electronic device, the at least one mechanical connector configured to connect to a corresponding mechanical connector of another of the plurality of electronic devices;
the plurality of electronic devices interconnecting to align the corresponding first display screens in a plurality of patterns including a correct pattern in which the various parts of the composite image are arranged to display the composite image.

2. The reconfigurable puzzle of claim 1, further comprising a haptics unit in signal communication with the processing unit corresponding to at least one of the plurality of electronic devices, the haptics unit comprising at least one actuator integrated with a surface of at least one electronic device from among the puzzle, wherein said haptics unit can generate at least one different touch sensation in a human extremity that is touching said surface, the haptics unit being in signal communication with the display screen and configured to generate a touch sensation corresponding to the part of the composite image displayed on the display screen.

3. The reconfigurable puzzle of claim 1, wherein:
at least one connector disposed on at least one electronic device connecting to a corresponding another connector of another electronic device includes at least two conductors configured to form at least two electrical connections between the corresponding electronic device and another electronic device when the connector and the another connector connect;
the at least two wires in the wired data interface in each of the plurality of electronic devices are connected to the at least two conductors, such that the conductors in the connectors form a wired data connection that facilitates the exchange of digitally encoded information between the processing units of any connected electronic devices;
any subset of the electronic devices of the puzzle can be connected together facilitated by more than one connector disposed on the electronic device; and
the subset forms a wired peer data network facilitating the exchange of data among connected electronic devices.

4. The reconfigurable puzzle of claim 3, wherein at least one of the plurality of electronic devices is connected to at least one external device through a wireless communication network including but not limited to, Bluetooth Low Energy, WiFi, or any other wireless network based on electromagnetic waves, wherein the external device is used to configure each of the at least one display screens of each individual puzzle piece to display parts of a composite image.

5. The reconfigurable puzzle of claim 4, wherein the at least one external device is operated by a medical professional, therapist, or educators to configure the puzzle in a way that serves a medical, therapy, or educational goal.

6. A reconfigurable puzzle for providing education, therapy, cognitive diagnostics, or entertainment, the puzzle comprising:
a plurality of electronic devices each operating as individual puzzle pieces, each of the plurality of electronic devices comprising:
a processing unit having at least one wired interface including at least two wires, the processing unit configured to transmit and receive data via the at least one wired interface;
a means to store energy in each electronic device, such as a battery or supercapacitor;
at least one electronic display screen on one side of the electronic device and in signal communication with the processing unit, the first display screen being reconfigurable to display various parts of a composite image; and
at least one mechanical connector disposed on at least one of a plurality of sides of the electronic device, the at least one mechanical connector configured to connect to a corresponding mechanical connector of another of the plurality of electronic devices;
the plurality of electronic devices interconnecting to align the corresponding first display screens in a plurality of patterns including a correct pattern in which the various parts of the composite image are arranged to display the composite image.

7. The reconfigurable puzzle of claim 6, wherein two connectors on different electronic devices are configured to form an attachment that exerts an attractive force such as friction or magnetism once the corresponding connectors are mated and an attempt is made to pull them apart with a force below a separation threshold.

8. The reconfigurable puzzle of claim 6, wherein the connected electronic devices are configured to transfer stored electric energy from the one electronic device to the other electronic device.

9. The reconfigurable puzzle of claim 6, wherein at least one connector disposed on at least one electronic device connecting to a corresponding another connector of another electronic device includes at least two conductors configured to form two electrical connections between the corresponding electronic device and another electronic device when the connector and the another connector connect.

10. The reconfigurable puzzle of claim 9, wherein the at least two wires in the wired data interface in a each of the plurality of electronic devices are connected to the at least two conductors in the connector disposed on each of the corresponding electronic device, wherein the conductors in the connectors are configured to form a wired data connection that facilitates the exchange of digitally encoded information between the processing units of a pair of connected electronic devices,

11. The reconfigurable puzzle of claim 10, wherein each of the electronic devices from among a selected subset of the plurality of electronic devices is assigned a unique identifier within the reconfigurable puzzle, wherein the unique identifiers of two connected electronic devices are exchanged through the wired data connection.

12. The reconfigurable puzzle of claim 11, wherein data are exchanged through wired data connections among a grouping among the subset of the plurality of electronic devices, wherein the electronic devices within said grouping are all connected together to form a wired peer network, allowing for data to be exchanged directly between two electronic devices connected directly through a wired data connection, or indirectly, relayed through any number of other electronic devices.

13. The reconfigurable puzzle of claim 12, wherein data exchanged among the grouping forming a wired peer network may be accompanied by a source address that may correspond to the unique identifier corresponding to the electronic device associated with one of:
origination of the data; and
a destination address corresponding to another unique identifier corresponding to the electronic device indicating the final destination of the data.

14. The reconfigurable puzzle of claim 13, wherein the exchanged data include visual data for output on an electronic display screen of a specific electronic device, data processed or generated within a specific electronic device, or any other data.

15. The reconfigurable puzzle of claim 11, wherein a person attempts to assemble the puzzle by connecting electronic devices, wherein connections between any two electronic devices are analyzed, using their unique identifiers, whether they comprise part of a correct pattern.

16. The configurable puzzle of claim 15, wherein the assembly timing is tracked, wherein the time stamps of correct connections and of incorrect connections are tracked and recorded as an assembly record in a storage unit in signal communication with one or more of the plurality of electronic devices.

17. The reconfigurable puzzle of claim 16, wherein the assembly record is analyzed and compared with a metric of cognitive functioning acquired using at least one independent cognitive test.

18. The reconfigurable puzzle of claim 17, wherein the comparison of the assembly metric with cognitive tests is repeated with a number of persons exhibiting a range of cognitive test scores according to at least one independent cognitive test, resulting in a correlation of the assembly metric with the cognitive functioning of a person assembling the puzzle.

19. The reconfigurable puzzle of claim 18, wherein a person with unknown cognitive abilities assembles the puzzle, and a puzzle-derived metric of cognitive functioning is derived from the puzzle assembly alone.

20. The reconfigurable puzzle of claim 19, wherein various follow-up treatment options including but not limited to, cognitive therapy, medication, exercise, or dietary changes are recommended based on the puzzle-derived metric.

21. The reconfigurable puzzle of claim 17, wherein the at least one cognitive test the assembly record is compared is known, within clinical practice, to represent an indication of at least one neurodegenerative disease or neurological disorder including but not limited to Alzheimer's, other dementias, Parkinsons's disease, or any other disorder.

22. The reconfigurable puzzle of claim 6, wherein at least one among the electronic display screens is configured to display a series of images in rapid succession, such as a movie.

23. The reconfigurable puzzle of claim 6, wherein more than one pattern in which the various parts of the composite images are aligned represents a correct pattern.

24. The reconfigurable puzzle of claim 6, wherein the puzzle is configured to display images corresponding to educational, learning, or therapy goals of specific individuals.

25. The reconfigurable puzzle of claim 6, wherein at least one of the plurality of electronic devices is connected to at least one external device through a wireless communication network including but not limited to, Bluetooth Low Energy, WiFi, or any other wireless network based on electromagnetic waves, wherein the external device is used to configure each of the at least one display screens of each individual puzzle piece to display parts of a composite image.

26. The reconfigurable puzzle of claim 25, wherein the external device is operated by a medical professional, therapist, or educators to configure the puzzle in a way that serves a medical, therapy, or educational goal.

27. The reconfigurable puzzle of claim 26, wherein the puzzle is configured by therapists or special education professionals to engage with specific interests of individuals with autism spectrum disorder.

28. The reconfigurable puzzle of claim 1, further comprising at least one sensor disposed on at least one of the plurality of electronic devices, wherein the at least one sensor is connected to the processing unit or another processing unit specialized on analyzing sensor data, within the corresponding electronic device.

29. The reconfigurable puzzle of claim 28, wherein the at least one sensor is actuated to result in the generation of instructions to display a modified image segment on any one electronic display screen of the same electronic device the sensor is integrated in or display another modified image segment on any one electronic display screen of at least one among any other electronic device from among the puzzle.

30. The reconfigurable puzzle of claim 28, wherein the at least one sensor is one or more audio sensors connected to the processing unit or another processing unit configured to encode audio signals.

31. The reconfigurable puzzle of claim 28, wherein the at least one sensor is at least one touchscreen integrated with, or laid over, at least one electronic display screen corresponding to the at least one electronic device, wherein the at least one touchscreen is connected to the processing unit or at least one touchscreen processing unit configured to encode tactile sensor signals.

32. The reconfigurable puzzle of claim 31, wherein interactions of a person with the puzzle, including connection events between any electronic devices, and interactions with any touchscreen on any electronic devices, are detected by the at least one sensor and tracked and recorded as an interaction record in a storage unit connected to all electronic devices.

33. The reconfigurable puzzle of claim 32, wherein the interaction record is analyzed for purposes of cognitive testing, other therapy or clinical applications, educational testing, or competition in a game.

34. The reconfigurable puzzle of claim 6, wherein at least one of the plurality of electronic device further comprises a haptics unit in signal communication with the processing unit, the haptics unit comprising at least one actuator integrated into each display screen that can generate at least one different touch sensation in a human extremity that is touching the display screen.

35. The reconfigurable puzzle of claim 34, wherein the haptics unit is configured for assembly of a composite puzzle by persons with visual impairment.
